(19) United States
(12) Patent Application Publication
(10) Pub. No.: US 2026/0122269 A1
(43) Pub. Date: Apr. 30, 2026

(54) V-DMC TRANSFORM RELATED CODING

(71) Applicant: QUALCOMM Incorporated, San Diego, CA (US)

(72) Inventors: Geert Van der Auwera, San Diego, CA (US); Reetu Hooda, San Diego, CA (US); Anique Akhtar, San Diego, CA (US); Adarsh Krishnan Ramasubramonian, Irvine, CA (US); Marta Karczewicz, San Diego, CA (US)

(21) Appl. No.: 19/367,575

(22) Filed: Oct. 23, 2025

Related U.S. Application Data
(60) Provisional application No. 63/711,585, filed on Oct. 24, 2024.
(60) Provisional application No. 63/776,796, filed on Mar. 24, 2025.

(51) Int. Cl. H04N 19/54; H04N 19/105; H04N 19/139; H04N 19/196

(52) U.S. Cl. CPC H04N 19/54; H04N 19/105; H04N 19/139; H04N 19/196

(57) ABSTRACT

A method of decoding meshpatch data includes determining that a first meshpatch of a first mesh is coded as an inter-meshpatch, determining that information indicative of a transform, applied to a first displacement associated with the first meshpatch, is not signaled, in response to the information indicative of the transform not being signaled, determining the transform, applied to the first displacement associated with the first meshpatch, based on transform information included in an atlas frame parameter set (AFPS), and decoding the first meshpatch based on the transform.

This application claims the benefit of U.S. Provisional Application No. 63/711,585, filed Oct. 24, 2024 and U.S. Provisional Application No. 63/776,796, filed Mar. 24, 2025, the entire contents of each are incorporated by reference herein.

### TECHNICAL FIELD

This disclosure relates to video-based coding of dynamic meshes.

### BACKGROUND

Meshes may be used to represent physical content of a 3-dimensional space. Meshes may have utility in a wide variety of situations. For example, meshes may be used in the context of representing the physical content of an environment for purposes of positioning virtual objects in an extended reality, e.g., augmented reality (AR), virtual reality (VR), or mixed reality (MR), application. Mesh compression is a process for encoding and decoding meshes. Encoding meshes may reduce the amount of data required for storage and transmission of the meshes.

### SUMMARY

This disclosure describes example techniques related to signaling and parsing of displacement transform related to various parameters in dynamic mesh representation (V-DMC). The example techniques are described with respect to parameters (e.g., syntax elements) for intra-meshpatch, inter-meshpatch, and merge meshpatch. For instance, the example techniques may reduce parsing dependency to promote parallel parsing of syntax elements. In one or more examples, the example techniques may allow enabling or disabling of coding tools at different sub-levels to improve coding performance. In this manner, the example techniques may provide practical applications that improve the overall V-DMC technology.

In one example, this disclosure describes a method of decoding meshpatch data, the method comprising determining that a first meshpatch of a first mesh is coded as an inter-meshpatch, determining that information indicative of a transform, applied to a first displacement associated with the first meshpatch, is not signaled, in response to the information indicative of the transform not being signaled, determining the transform, applied to the first displacement associated with the first meshpatch, based on transform information included in an atlas frame parameter set (AFPS), and decoding the first meshpatch based on the transform.

In another example, this disclosure describes a device for decoding meshpatch data, the device comprising one or more memories, and processing circuitry coupled to the one or more memories, the processing circuitry being configured to determine that a first meshpatch of a first mesh is coded as an inter-meshpatch, determine that information indicative of a transform, applied to a first displacement associated with the first meshpatch, is not signaled, in response to the information indicative of the transform not being signaled, determine the transform, applied to the first displacement associated with the first meshpatch, based on transform information included in an atlas frame parameter set (AFPS), and decode the first meshpatch based on the transform.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example of a V-DMC decoding process.

FIG. 3 shows an example of resampling to enable efficient compression of a 2D curve.

FIG. 4 shows a displaced curve that has a subdivision structure, while approximating the shape of the original mesh.

FIG. 5 shows a block diagram of a pre-processing system.

FIG. 6 shows an example of an intra frame encoding process.

FIG. 7 shows an example of an intra frame decoding process.

FIG. 8 shows a block diagram of an arithmetic decoding process of displacements bitstream.

FIG. 9 shows an example of a mid-point subdivision scheme.

FIG. 10 is a flowchart illustrating an example method of operation.

FIG. 11 is another flowchart illustrating an example method of operation.

FIG. 12 is another flowchart illustrating an example method of operation.

FIG. 13 is another flowchart illustrating an example method of operation.

### DETAILED DESCRIPTION

This disclosure describes techniques that may improve the signaling and parsing of displacement transform related parameters used in dynamic mesh representations (V-DMC). Examples of the parameters include the intra-meshpatch, inter-meshpatch, and merge-meshpatch syntax.

In V-DMC, a V-DMC encoder may be configured to encode a mesh data of a mesh. A mesh may be an interconnection of vertices of a plurality of primitives (e.g., triangles) to form a realistic three-dimensional model. To perform encoding, the V-DMC encoder may separate the mesh into a plurality of sub-meshes, also called meshpatches. The V-DMC encoder may encode the meshpatches to encode the mesh.

The encoding process includes the V-DMC generating a plurality of sub-bitstreams that together form the bitstream representing the encoded mesh. The basemesh sub-bitstream includes a simplified version of the mesh. The displacement sub-bitstream includes information about changes in vertex positions to reconstruct the mesh at a higher level of detail. Attribute sub-bitstream includes information about surface properties such as texture, color, etc. Each meshpatch may include corresponding sub-bitstreams, like those described above.

The meshpatches of one mesh or different meshes may be encoded as intra-meshpatches, inter-meshpatches, and merge-meshpatches. Intra-meshpatches refer to meshpatches that can be encoded and decoded without reference to a meshpatch in another mesh. That is, intra-meshpatches are encoded or decoded with respect to vertices within the same mesh. Accordingly, a reference meshpatch of a meshpatch coded as an intra-meshpatch is in the same mesh as the meshpatch being encoded or decoded. In an intra-meshpatch, the vertices of the meshpatch are predicted using the vertices within the same meshpatch, independent of the reference meshpatch.

Inter-meshpatches and merge-meshpatches refer to meshpatches that are encoded or decoded with reference to a meshpatch in another mesh. That is, the reference meshpatch for an inter-meshpatch or merge-meshpatch may be in another mesh. In an inter-meshpatch, the vertices of the meshpatch are predicted from vertices of the reference meshpatch of another mesh. In a merge-meshpatch, the vertices of the meshpatch are inherited from vertices of the reference meshpatch of another mesh.

In various coding scenarios, the selection between intra-, inter-, and merge-meshpatch types may be based on the relationship between a current meshpatch and its reference meshpatch. For example, a merge-meshpatch may be used when the number of vertices in the current meshpatch is identical or nearly identical to the number of vertices in the reference meshpatch. This assumption extends to other parameters, such as the number of subdivision iterations, the displacement transform type, and the subdivision schemes being the same between the current and reference patch. In such cases, delta coding of certain tool parameters, such as lifting offset parameters or inverse quantization offset parameters, may be signaled to maintain high coding efficiency.

Conversely, an intra-meshpatch may be used when significant configuration changes occur between the current meshpatch and its reference. The intra-meshpatch syntax allows for the signaling of an entirely new configuration for the current meshpatch, such as a different number of subdivision iterations, a different transform type, or different subdivision methods. The inter-meshpatch may be used in scenarios between these two, and to clarify its role, this disclosure provides for a conformance requirement where the number of subdivision iterations for an inter-meshpatch is less than or equal to the number of subdivision iterations of its reference meshpatch. This positions the inter-meshpatch as a tool for predicting a meshpatch with reduced or equivalent complexity relative to its reference.

The V-DMC encoder may be configured to perform a lifting transform (e.g., as part of a wavelet transform on the displacement sub-bitstream) and the V-DMC decoder may be configured to perform an inverse of the lifting transform (e.g., as part of an inverse wavelet transform on the displacement sub-bitstream). The lifting transform may include converting spatial geometry data (e.g., 3D coordinates of vertices of the meshpatches) into a multi-resolution format that is computationally efficient for compression.

For instance, vertices of a meshpatch may be represented by displacement vectors from the basemesh. If the basemesh is intra-coded (e.g., without reference to another mesh), the meshpatch is an intra-meshpatch. If the basemesh is inter-coded or merge-coded (e.g., with reference to another mesh), the meshpatch is an inter-meshpatch or merge-meshpatch, respectively. For intra-meshpatch, inter-meshpatch, and merge-meshpatch, there may be displacement vectors that are encoded or decoded as part of the displacement sub-bitstream, that may be used to increase the vertices and increase resolution (e.g., detail), such that when the vertices generated using the displacement vectors are added to the basemesh, the resulting mesh has higher resolution.

The lifting transform may indicate the manner in which the additional vertices are generated. For example, the lifting transform receives the displacement vectors as inputs and decomposes the displacement vectors into a more compressible format. The lifting transform effectively separates the geometry into a low-resolution, coarse approximation of the mesh shape. The lifting transform also generates a series of wavelet coefficients, which represent the fine details and surface intricacies at different levels of resolution. In some examples, the lifting transform may be hierarchical, where sets of vertices are iteratively added to the basemesh to generate different levels of resolution. The lifting transform process ends when the desired level of the resolution is achieved.

There may be various parameters that define a manner in which the lifting transform is to be applied. For example, some parameters may define lifting parameters such as lifting offsets or lifting offset delta values. There may be various ways in which such lifting parameters can be selectively signaled. This disclosure describes example ways in which lifting parameters are selectively signaled in a manner that reduces parsing dependency. Parsing dependency refers to the V-DMC decoder being required to parse some information or access such information from memory for another mesh before the V-DMC decoder needs to come back to decoding current parameters. There may be some parsing dependency with the techniques of this disclosure, but the impact of the parsing dependency may be minimized. For example, the example techniques may allow enabling or disabling of coding tools at different sub-levels to improve coding performance.

As one example, for a meshpatch coded as an inter-meshpatch, some of the parameters can be determined from a reference meshpatch. In some cases, for the V-DMC decoder to retrieve parameters of the reference meshpatch may require the V-DCM decoder to access off-chip memory (e.g., memory from which information is retrieved more slowly compared to other memories). Such access may negatively impact how quickly the decoding can occur. Furthermore, there may not be a manner in which to specify at a meshpatch level whether parameters for a particular meshpatch are signaled in the bitstream or accessed from elsewhere.

In one or more examples, the V-DMC decoder may determine that information indicative of a transform, applied to a displacement associated with the meshpatch, is not signaled. The term “displacement” and “displacement vector” are used interchangeably. For instance, the V-DMC decoder may parse a flag indicating that the information indicative of the transform is not signaled. An example of the flag is imdu_transform_method_override_flag. The imdu_transform_method_override_flag being true means that information indicative of the transform for the meshpatch is signaled. The imdu_transform_method_override_flag being false means that information indicative of the transform for the meshpatch is not signaled.

In response to the information indicative of the transform not being signaled, the V-DMC decoder may determine the transform, applied to the displacement associated with the meshpatch, based on transform information included in an atlas frame parameter set (AFPS). For example, the V-DMC decoder may bypass access to memory that stores the information indicative of the transform applied to a displacement associated with a reference meshpatch for the meshpatch. This way, the V-DMC decoder may determine the transform that is applied to the meshpatch based on information in the AFPS rather than accessing the information indicative of the transform from the memory that stores such information for the reference meshpatch.

In some examples, the meshpatches that are inter-meshpatches may be further subdivided. In one or more examples, a value of a number of subdivision iterations for the meshpatch is less than or equal to a number of subdivisions of the reference meshpatch (e.g., a reference meshpatch for the meshpatch).

Another example parameter for the transform is whether lifting offsets are present or not in a bitstream. This disclosure describes examples of syntax elements used to indicate whether lifting offsets are present or not in the bitstream. In this manner, the example techniques may allow per meshpatch control of whether to include or not lifting offsets in the bitstream.

As one example, the V-DMC decoder may parse a flag, received in a bitstream, indicative of whether a lifting offset is applied to a displacement associated with a meshpatch of a mesh that is coded as an inter-meshpatch. For example, the V-DMC decoder may parse the imdu_lifting_offset_present_flag that indicates whether the lifting offset is applied to a displacement associated with the meshpatch (e.g., inter-meshpatch). The V-DMC decoder may determine whether the lifting offset is applied to the displacement associated with the meshpatch based on the flag (e.g., based on the imdu_lifting_offset_present_flag).

As another example, the V-DMC decoder may parse a flag, received in a bitstream, indicative of whether a lifting offset is applied to a displacement associated with a meshpatch of a mesh that is coded as a merge-meshpatch. For example, the V-DMC decoder may parse the mmdu_lifting_offset_present_flag that indicates whether the lifting offset is applied to a displacement associated with the meshpatch (e.g., merge-meshpatch). The V-DMC decoder may determine whether the lifting offset is applied to the displacement associated with the meshpatch based on the flag (e.g., based on the mmdu_lifting_offset_present_flag).

In some examples, the flag indicative of whether the lifting offset is applied has same value as a flag, associated with a reference meshpatch for the meshpatch (e.g., merge-meshpatch), indicative of whether the lifting offset is applied to the reference meshpatch. That is, the value of mmdu_lifting_offset_present_flag for the meshpatch should be same as the value of mmdu_lifting_offset_present_flag for the reference meshpatch.

As another example, the V-DMD decoder may parse a flag, received in a bitstream, indicative of whether a lifting offset is applied to a displacement associated with a meshpatch of a mesh that is coded as an intra-meshpatch. For example, the V-DMC decoder may parse the mdu_lifting_offset_present_flag that indicates whether the lifting offset is applied to a displacement associated with a meshpatch (e.g., intra-meshpatch). The V-DMC decoder may determine whether the lifting offset is applied to the displacement associated with the meshpatch based on the flag (e.g., based on the mdu_lifting_offset_present_flag).

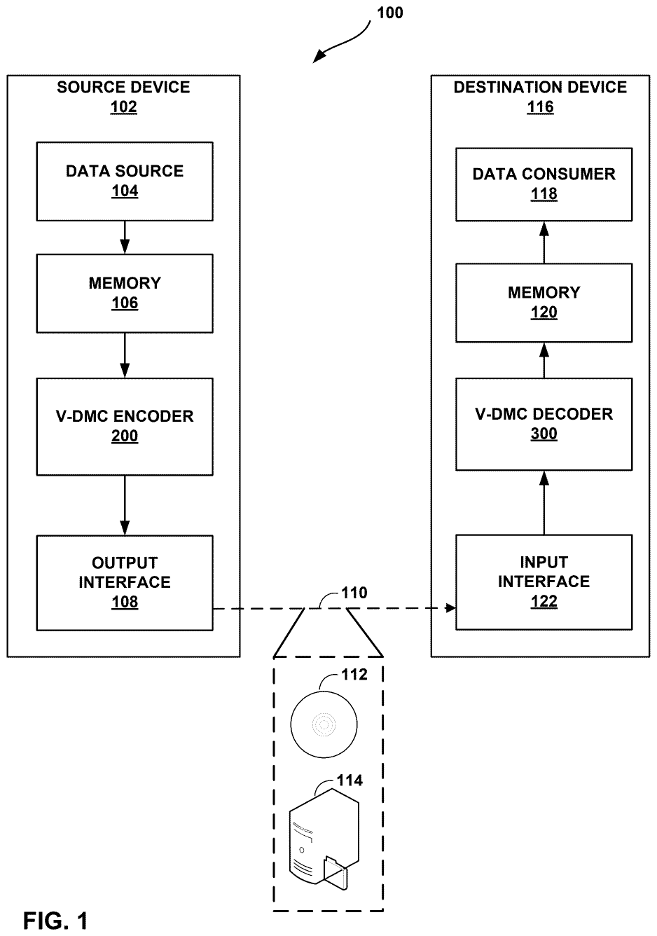

FIG. 1 is a block diagram illustrating an example encoding and decoding system 100 that may perform the techniques of this disclosure. The techniques of this disclosure are generally directed to coding (encoding and/or decoding) meshes. The coding may be effective in compressing and/or decompressing data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to mesh motion field coding. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to mesh motion field coding. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded data) and may provide a sequential series of “frames”) of the data to V-DMC encoder 200, which encodes data for the frames. Data source 104 of source device 102 may include a mesh capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, mesh data may be computer-generated from scanner, camera, sensor or other data. For example, data source 104 may generate computer graphics-based data as the source data, or produce a combination of live data, archived data, and computer-generated data. In each case, V-DMC encoder 200 encodes the captured, pre-captured, or computer-generated data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to V-DMC encoder 200 and/or output interface 108, and destination device 116 may include an SoC device to perform the functionality attributed to V-DMC decoder 300 and/or input interface 122.

The techniques of this disclosure may be applied to encoding and decoding in support of any of a variety of applications, such as communication between vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

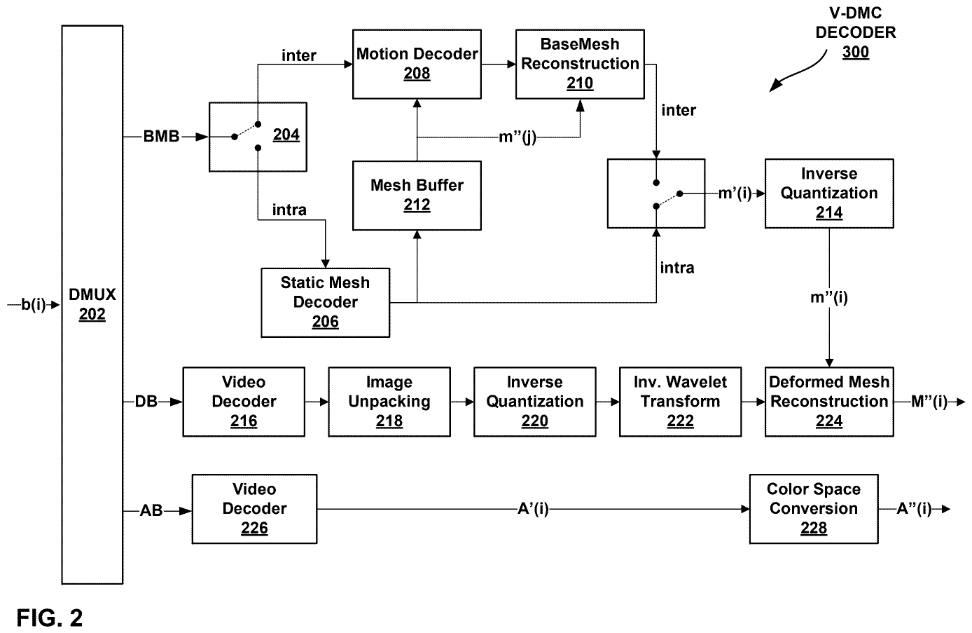

The MPEG working group 7 (WG7), also known as the 3D graphics and haptics coding group (3DGH), is currently standardizing the video-based coding of dynamic mesh representations (V-DMC) targeting XR use cases. The current test model is based on the call for proposals result, Khaled Mammou, Jungsun Kim, Alexandros Tourapis, Dimitri Podborski, Krasimir Kolarov, [V-CG] Apple's Dynamic Mesh Coding CfP Response, ISO/IEC JTC1/SC29/WG7, m59281, April 2022, and encompasses the pre-processing of the input meshes into approximated meshes with typically fewer vertices named the basemeshes, which are coded with a static mesh coder (e.g., Google Draco, MPEG's edge breaker implementation, etc.). In addition, V-DMC encoder 200 may estimate the motion of the basemesh vertices and code the motion vectors into the bitstream. The reconstructed basemeshes may be subdivided into finer meshes with additional vertices and, hence, additional triangles. The V-DMC encoder 200 may refine the positions of the subdivided mesh vertices to approximate the original mesh. The refinements or vertex displacement vectors may be coded into the bitstream. In the current test model, the displacement vectors are wavelet transformed (lifting scheme), quantized, and the coefficients are either packed into a 2D frame or directly coded with an arithmetic coder after inter-prediction. The sequence of frames is coded with a typical video coder, for example, High Efficiency Video Coding (HEVC) or Versatile Video Coding (VVC), into the bitstream. In addition, the sequence of texture frames is coded with a video coder. The architecture of the V-DMC decoder is illustrated in FIG. 2.

FIG. 2 shows an example of a V-DMC decoding process as set forth in Working Draft (WD) 2.0 of V-DMC, ISO/IEC JTC1/SC29/WG7, N00546, January 2023. The process of FIG. 2 may be performed by V-DMC decoder 300 and may also be performed, in full or in part, by V-DMC encoder 200.

V-DMC decoder 300 includes demultiplexer (DMUX) 202, which receives compressed bitstream b(i) and separates the compressed bitstream into a basemesh bitstream (BMB), also called basemesh sub-bitstream, a displacement bitstream (DB), also called displacement sub-bitstream, and an attribute bitstream (AB), also called attribute sub-bitstream. Mode select unit 204 determines if the basemesh data is encoded in an intra mode or an inter mode. If the basemesh is encoded in an intra mode, then static mesh decoder 206 decodes the mesh data without reliance on any previously decoded meshes. If the basemesh is encoded in an inter mode, then motion decoder 208 decodes motion, and basemesh reconstruction unit 210 applies the motion to an already decoded mesh (m″(j)) stored in mesh buffer 212 to determine a reconstructed quantized basemesh (m′(i))). Inverse quantization unit 214 applies an inverse quantization to the reconstructed quantized basemesh to determine a reconstructed basemesh (m″(i)).

Video decoder 216 decodes the displacement bitstream to determine a set or frame of quantized transform coefficients. Image unpacking unit 218 unpacks the quantized transform coefficients. For example, video decoder 216 may decode the quantized transform coefficients into a frame, where the quantized transform coefficients are organized into blocks with particular scanning orders. Image unpacking unit 218 converts the quantized transform coefficients from being organized in the frame into an ordered series. In some implementations, the quantized transform coefficients may be directly coded, using a context-based arithmetic coder for example, and unpacking may be unnecessary.

Regardless of whether the quantized transform coefficients are decoded directly or in a frame, inverse quantization unit 220 inverse quantizes, e.g., inverse scales, quantized transform coefficients to determine de-quantized transform coefficients. Inverse wavelet transform unit 222 applies an inverse transform to the de-quantized transform coefficients to determine a set of displacement vectors. Deformed mesh reconstruction unit 224 deforms the reconstructed basemesh using the decoded displacement vectors to determine a decoded mesh (M″(i)).

Video decoder 226 decodes the attribute bitstream to determine decoded attribute values (A′(i)), and color space conversion unit 228 converts the decoded attribute values into a desired color space to determine final attribute values (A″(i)). The final attribute values correspond to attributes, such as color or texture, for the vertices of the decoded mesh.

A detailed description of the proposal that was selected as the starting point for the V-DMC standardization can be found in m59281. The following description will detail the displacement vector coding in the current V-DMC test model and WD 2.0, such as WD 5.0 of V-DMC, ISO/IEC JTC1/SC29/WG7, N00744, October 2023. Additionally, the coding of the basemesh motion field is described.

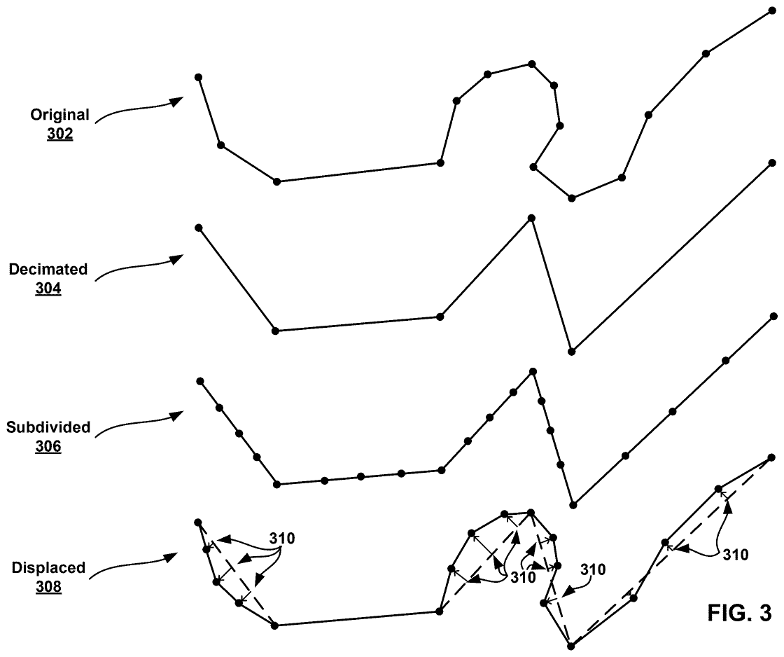

V-DMC encoder 200 and V-DMC decoder 300 may be configured to perform preprocessing. FIG. 3 illustrates examples of proposed pre-processing scheme by using a 2D curve. The same concepts are applied to the input 3D mesh M(i) to produce a basemesh m(i) and a displacement field d(i).

In FIG. 3, the input 2D curve (represented by a 2D polyline), referred to as the original curve 302, is first downsampled to generate a base curve/polyline, referred to as the decimated curve 304. A subdivision scheme, such as that described in Garland et al, Surface Simplification Using Quadric Error Metrics (https://www.cs.cmu.edu/˜garland/Papers/quadrics.pdf), is then applied to the decimated polyline to generate a “subdivided” curve. For instance, in FIG. 3, a subdivision scheme using an iterative interpolation scheme is applied. It consists of inserting at each iteration a new point in the middle of each edge of the polyline. In the example illustrated, two subdivision iterations were applied.

In some examples, the techniques are independent of the chosen subdivision scheme and could be combined with other subdivision schemes. The subdivided polyline is then deformed, or displaced, to get a better approximation of the original curve. This better approximation is displaced curve 308 in FIG. 3.

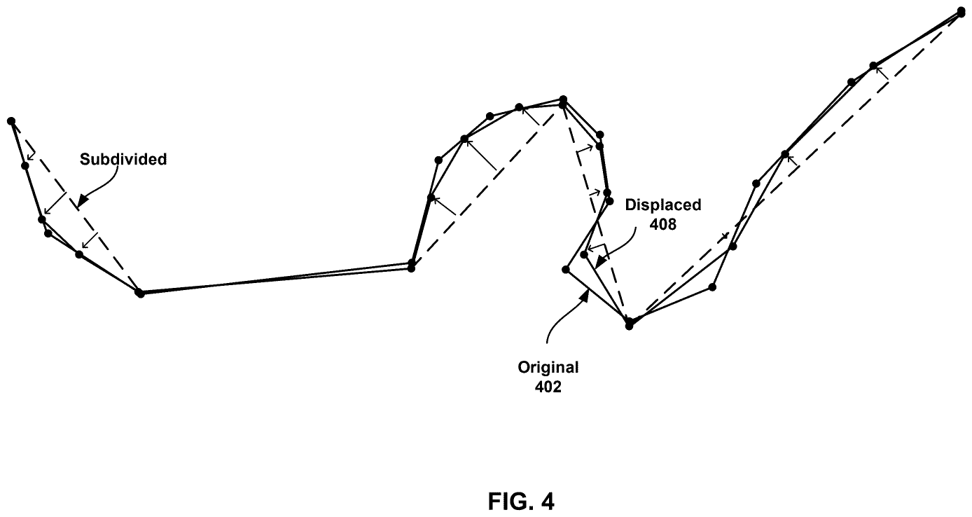

For example, displacement vectors (arrows 310 in FIG. 3) are computed for each vertex of the subdivided mesh such that the shape of the displaced curve is as close as possible to the shape of the original curve (see FIG. 4). In FIG. 4, as illustrated by portion 408 of displaced curve 308 (FIG. 3) and portion 402 of original curve 302 (FIG. 3), for example, the displaced curve may not perfectly match the original curve.

One possible advantage of the subdivided curve is that the subdivided curve has a subdivision structure that allows efficient compression, while the subdivided curve offers a faithful approximation of the original curve. The compression efficiency is obtained for possibly the following properties:
The decimated/base curve has a low number of vertices and requires a limited number of bits to be encoded/transmitted.
The subdivided curve is automatically generated by the decoder once the base/decimated curve is decoded (i.e., no need for any information other than the subdivision scheme type and subdivision iteration count).
The displaced curve is generated by decoding the displacement vectors associated with the subdivided curve vertices. Besides allowing for spatial/quality scalability, the subdivision structure enables efficient transforms such as wavelet decomposition, which can offer high compression performance.

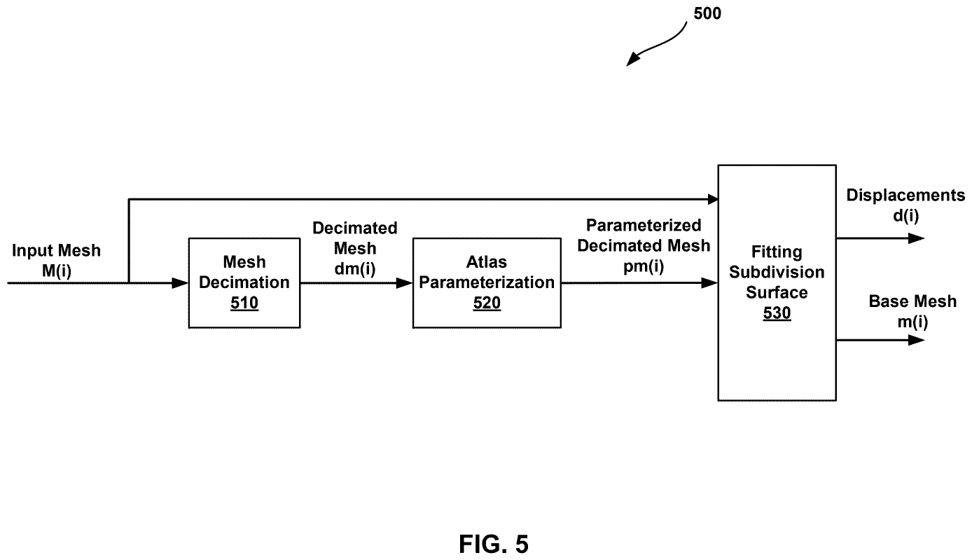

FIG. 5 shows a block diagram of a pre-processing scheme that includes the following sub-blocks (1) Mesh decimation, (2) Atlas parameterization, and (3) Subdivision surface fitting.

The mesh decimation module uses a simplification technique to decimate the input mesh M(i) and produce the decimated mesh dm(i). The decimated mesh dm(i) is then re-parameterized using the UVAtlas tool (e.g., https://docs.microsoft.com/en-us/windows/win32/direct3d9/using-uvatlas). The generated mesh is denoted as pm(i). The UVAtlas tool considers only the geometry information of the decimated mesh dm(i) when computing the atlas parameterization, which is likely sub-optimal for compression purposes. Other parameterization schemes or tools could also be considered with the proposed framework.

FIG. 5 shows a block diagram of pre-processing system 500 which may be included in V-DMC encoder 200 or may be separate from V-DMC encoder 200. In the example of FIG. 5, pre-processing system 500 includes mesh decimation unit 510, atlas parameterization unit 520, and subdivision surface fitting unit 530.

Mesh decimation unit 510 uses a simplification technique to decimate the input mesh M(i) and produce the decimated mesh dm(i). The decimated mesh dm(i) is then re-parameterized by atlas parameterization unit 520, which may, for example, use the UVAtlas tool. The generated mesh is denoted as pm(i). The UVAtlas tool considers only the geometry information of the decimated mesh dm(i) when computing the atlas parameterization, which is likely sub-optimal for compression purposes. Better parameterization schemes or tools may also be considered with the proposed framework.

Applying re-parameterization to the input mesh makes it possible to generate a lower number of patches. This reduces parameterization discontinuities and may lead to better rate distortion (RD) performance. Subdivision surface fitting unit 530 takes as input the re-parameterized mesh pm(i) and the input mesh M(i) and produces the basemesh m(i) together with a set of displacements d(i). First, pm(i) is subdivided by applying the subdivision scheme. The displacement field d(i) is computed by determining for each vertex of the subdivided mesh the nearest point on the surface of the original mesh M(i).

For the Random Access (RA) condition, a temporally consistent re-meshing may be computed by considering the basemesh m(j) of a reference frame with index j as the input for subdivision surface fitting unit 530. This makes it possible to produce the same subdivision structure for the current mesh M′(i) as the one computed for the reference mesh M′(j). Such a re-meshing process makes it possible to skip the encoding of the basemesh m(i) and re-use the basemesh m(j) associated with the reference frame M(j). This may also enable better temporal prediction for both the attribute and geometry information. For example, a motion field f(i) describing how to move the vertices of m(j) to match the positions of m(i) is computed and encoded. Note that such time-consistent re-meshing is not always possible. The proposed system compares the distortion obtained with and without the temporal consistency constraint and chooses the mode that offers the best RD compromise.

Note that the pre-processing system may not be normative and may be replaced by any other system that produces displaced subdivision surfaces. A possible efficient implementation would constrain the 3D reconstruction unit to directly generate displaced subdivision surface and avoids the need for such pre-processing.

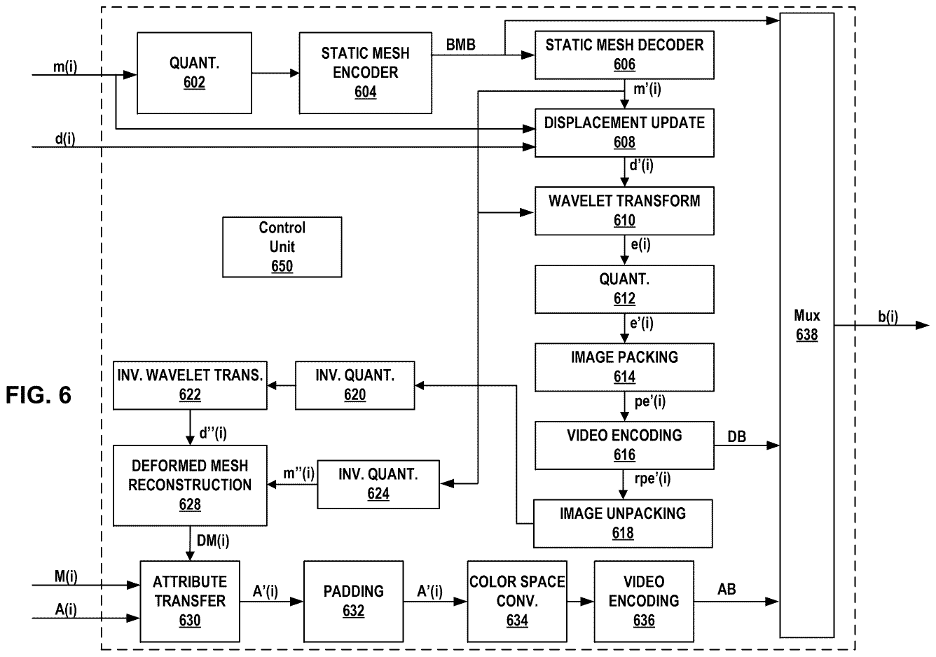

V-DMC encoder 200 and V-DMC decoder 300 may be configured to perform displacements coding. Depending on the application and the targeted bitrate/visual quality, the V-DMC encoder 200 could optionally encode a set of displacement vectors associated with the subdivided mesh vertices, referred to as the displacement field d(i). The intra encoding process, which may be performed by V-DMC encoder 200, is illustrated in FIG. 6.

FIG. 6 shows V-DMC encoder 600, which is configure to implement an intra encoding process. V-DMC encoder 600 represents an example implementation of V-DMC encoder 200.

FIG. 6 includes the following abbreviations:
m(i)—Basemesh
d(i)—Displacements
m″(i)—Reconstructed Basemesh
d″(i)—Reconstructed Displacements
A(i)—Attribute Map
A′(i)—Updated Attribute Map
M(i)—Static/Dynamic Mesh
DM(i)—Reconstructed Deformed Mesh
m′(i)—Reconstructed Quantized Basemesh
d′(i)—Updated Displacements
e(i)—Wavelet Coefficients
e′(i)—Quantized Wavelet Coefficients
pe′(i)—Packed Quantized Wavelet Coefficients
rpe′(i)—Reconstructed Packed Quantized Wavelet Coefficients
AB—Compressed attribute bitstream
DB—Compressed displacement bitstream
BMB—Compressed basemesh bitstream

V-DMC encoder 200 receives basemesh m(i) and displacements d(i), for example from pre-processing system 500 of FIG. 5. V-DMC encoder 200 also retrieves mesh M(i) and attribute map A(i).

Quantization unit 602 quantizes the basemesh, and static mesh encoder 604 encodes the quantized basemesh to generate a compressed basemesh bitstream that is output to static mesh decoder 606. Displacement update unit 608 uses the reconstructed quantized basemesh m′(i) from static mesh decoder 606 to update the displacement field d(i) to generate an updated displacement field d′(i). This process considers the differences between the reconstructed basemesh m′(i) and the original basemesh m(i). By exploiting the subdivision surface mesh structure, wavelet transform unit 610 applies a wavelet transform to d′(i) to generate a set of wavelet coefficients. The scheme is agnostic of the transform applied and may leverage any other transform, including the identity transform. Quantization unit 612 quantizes wavelet coefficients, and image packing unit 614 packs the quantized wavelet coefficients into a 2D image/video that can be compressed using a traditional image/video encoder to generate a displacement bitstream.

Attribute transfer unit 630 converts the original attribute map A(i) to an updated attribute map that corresponds to the reconstructed deformed mesh DM(i). Padding unit 632 pads the updated attributed map by, for example, filling patches of the frame that have empty samples with interpolated samples that may improve coding efficiency and reduce artifacts. Color space conversion unit 634 converts the attribute map into a different color space, and video encoding unit 636 encodes the updated attribute map in the new color space, using for example a video codec, to generate an attribute bitstream. Multiplexer 638 combines the compressed attribute bitstream, compressed displacement bitstream, and compressed basemesh bitstream into a single compressed bitstream.

Image unpacking unit 618 and inverse quantization unit 620 apply image unpacking and inverse quantization to the reconstructed packed quantized wavelet coefficients generated by video encoding unit 616 to obtain the reconstructed version of the wavelet coefficients. Inverse wavelet transform unit 622 applies an inverse wavelet transform to the reconstructed wavelet coefficient to determine reconstructed displacements d″(i).

Inverse quantization unit 624 applies an inverse quantization to the reconstructed quantized basemesh m′(i) to obtain a reconstructed basemesh m″(i). Deformed mesh reconstruction unit 628 subdivides m″(i) and applies the reconstructed displacements d″(i) to its vertices to obtain the reconstructed deformed mesh DM(i).

Image unpacking unit 618, inverse quantization unit 620, inverse wavelet transform unit 622, and deformed mesh reconstruction unit 628 represent a displacement decoding loop. Inverse quantization unit 624 and deformed mesh reconstruction unit 628 represent a basemesh decoding loop. V-DMC encoder 600 includes the displacement decoding loop and the basemesh decoding loop so that V-DMC encoder 600 can make encoding decisions, such as determining an acceptable rate-distortion tradeoff, based on the same decoded mesh that a mesh decoder will generate, which may include distortion due to the quantization and transforms. V-DMC encoder 600 may also use decoded versions of the basemesh, reconstructed mesh, and displacements for encoding subsequent basemeshes and displacements.

Control unit 650 generally represents the decision making functionality of V-DMC encoder 600. During an encoding process, control unit 650 may, for example, make determinations with respect to mode selection, rate allocation, quality control, and other such decisions.

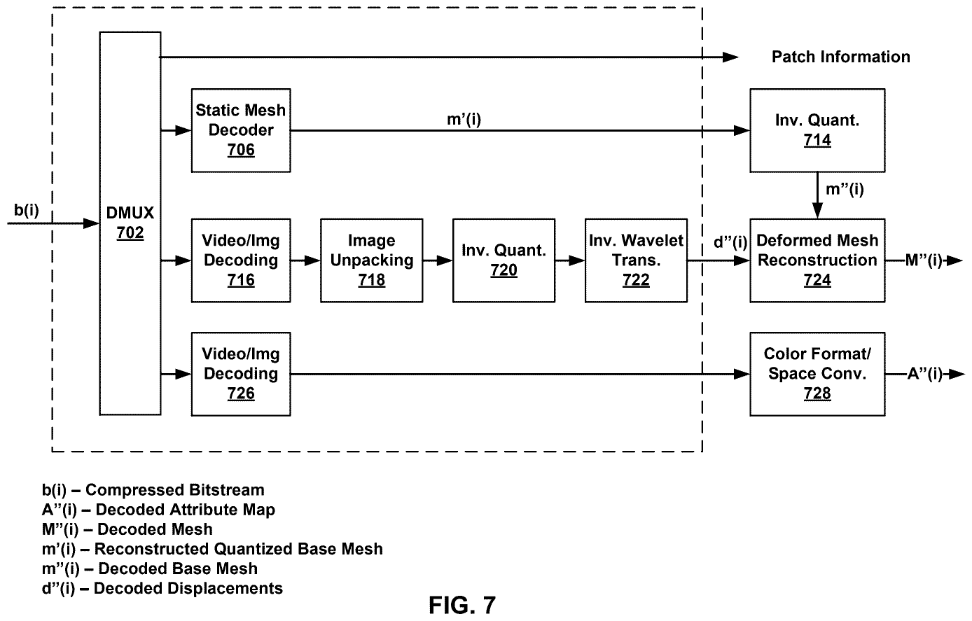

FIG. 7 shows a block diagram of an intra decoding process that may, for example, be performed by V-DMC decoder 300. De-multiplexer (DMUX) 702 separates compressed bitstream (bi) into a mesh sub-bitstream, a displacement sub-bitstream for positions and potentially for each vertex attribute, zero or more attribute map sub-bitstreams, and an atlas sub-bitstream containing patch information in the same manner as in V3C/V-PCC.

De-multiplexer 702 feeds the mesh sub-bitstream to static mesh decoder 706 to generate the reconstructed quantized basemesh m′(i). Inverse quantization unit 714 inverse quantizes the basemesh to determine the decoded basemesh m″(i). Video/image decoding unit 716 decodes the displacement sub-bitstream, and image unpacking unit 718 unpacks the image/video to determine quantized transform coefficients, e.g., wavelet coefficients. Inverse quantization unit 720 inverse quantizes the quantized transform coefficients to determine dequantized transform coefficients. Inverse wavelet transform unit 722 generates the decoded displacement field d″(i) by applying the inverse transform to the unquantized coefficients. Deformed mesh reconstruction unit 724 generates the final decoded mesh (M″(i)) by applying the reconstruction process to the decoded basemesh m″(i) and by adding the decoded displacement field d″(i). The attribute sub-bitstream is directly decoded by video/image decoding unit 726 to generate an attribute map A″(i). Color format/space conversion unit 728 may convert the attribute map into a different format or color space.

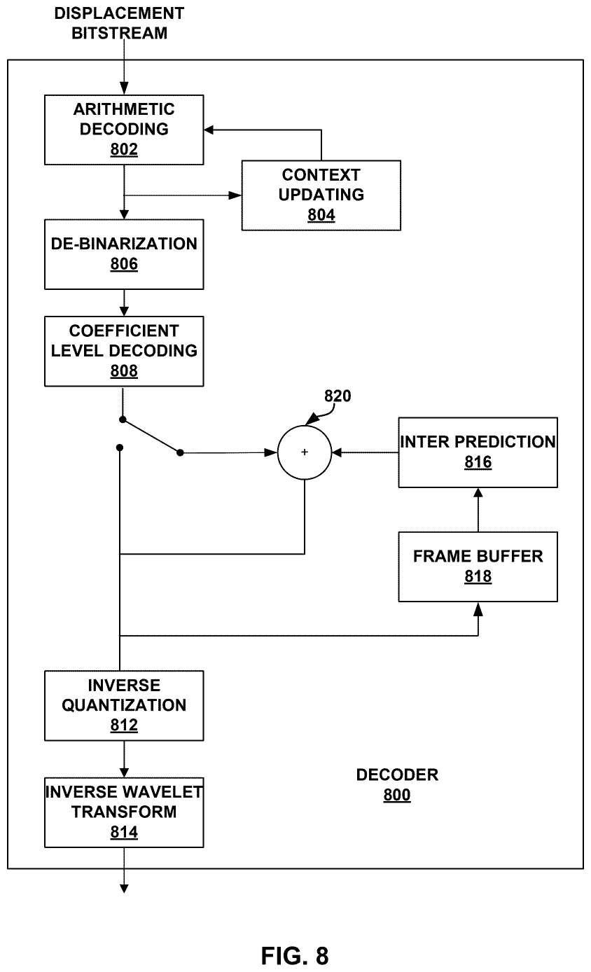

The following describes arithmetic coding of displacements. As an alternative to packing the quantized wavelet coefficients in frames and coding as images or video, a scheme was utilized that directly codes the quantized wavelet coefficients with a block-based arithmetic coder. This scheme is illustrated in FIG. 8. The decoded quantized wavelet coefficients are inter predicted from the reference buffer, which contains quantized wavelet coefficients from prior frames, for example, the preceding frame.

In the example of FIG. 8, decoder 800, which is an example of V-DMC decoder 300, performs context-based arithmetic decoding 802 of a displacement bitstream based on a context updating 804. Decoder 800 performs de-binarization 806 on the context decoded bitstream to determine values for syntax elements and performs coefficient level decoding 808 on the syntax elements. For intra coded displacements, decoder 800 performs inverse quantization 812 on the coefficient levels to determine de-quantized coefficient levels, and then performs an inverse wavelet transform 814 on the de-quantized coefficient levels to determine the displacements. For inter coded displacements, decoder 800 performs inter prediction 816 using reference frames stored in a frame buffer 818 and adds 820 the prediction values to the coefficient levels to determine final coefficient levels. Decoder 800 then performs inverse quantization 812 on the final coefficient levels to determine de-quantized coefficient levels, and then performs an inverse wavelet transform 814 on the de-quantized coefficient levels to determine the displacements.

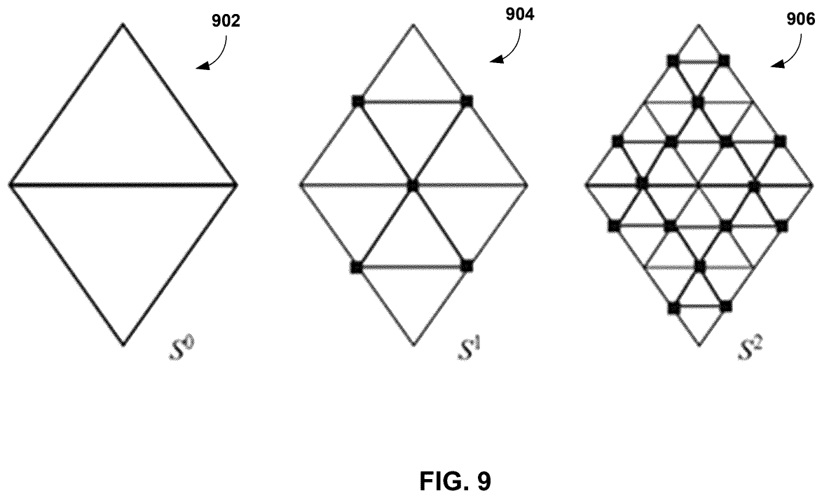

V-DMC encoder 200 and V-DMC decoder 300 may be configured to implement a subdivision process. Various subdivision processes could be considered (e.g., https://www.cs.utexas.edu/users/fussell/courses/cs384g-fall2011/lectures/lecture17-Subdivision_curves.pdf). A possible solution is the mid-point subdivision process, which at each subdivision iteration subdivides each triangle into four sub-triangles as described in FIG. 9. New vertices are introduced in the middle of each edge. In the example, FIG. 9, triangles 902 are subdivided to obtain triangles 904, and triangles 904 are subdivided to obtain triangles 906. The subdivision process is applied independently to the geometry and to the texture coordinates since the connectivity for the geometry and for the texture coordinates is usually different. The sub-division process computes the position Pos(v₁₂) of a newly introduced vertex v₁₂ at the center of an edge (v₁, v₂), as follows:

$$P o s ( {v}_{12} ) = \frac{1}{2} ( P o s ( {v}_{1} ) + P o s ( {v}_{2} ) ) ,$$

where Pos(v₁) and Pos(v₂) are the positions of the vertices v₁ and v₂.

The same process is used to compute the texture coordinates of the newly created vertex. For normal vectors, an extra normalization step is applied as follows:

$$N ( {v}_{12} ) = \frac{N ( {v}_{1} ) + N ( {v}_{2} )}{‖ N ( {v}_{1} ) + N ( {v}_{2} ) ‖} ,$$

here:
N(v₁₂), N(v₁), and N(v₂) are the normal vectors associated with the vertices v₁₂, v₁, and v₂, respectively.
∥x∥ is the norm2 of the vector x.

V-DMC encoder 200 and V-DMC decoder 300 may be configured to apply wavelet transforms. Various wavelet transforms may be applied (e.g., Kolarov, K and Lynch W. “Wavelet Compression for 3D and Higher-Dimensional Objects”, Proc. of SPIE Conference on Applications of Digital Image Processing, Volume 3164, San Diego, California, pp. 247-260, July 1997). The results reported for CfP are based on a linear wavelet transform.

The prediction process is defined as follows:

$$Signal ( v ) ← Signal ( v ) - \frac{1}{2} ( Signal ( {v}_{1} ) + Signal ( {v}_{2} ) )$$

where
v is the vertex introduced in the middle of the edge (v₁, v₂), and
Signal (v), Signal (v₁), and Signal (v₂) are the values of the geometry/vertex attribute signals at the vertices v, v₁, and v₂, respectively.

The updated process is as follows:

$$Signal ( v ) ← Signal ( v ) + \frac{1}{8} {\sum }_{w ∈ {v}^{*}} Signal ( w )$$

where v* is the set of neighboring vertices of the vertex v.

The scheme may allow to skip the update process. The wavelet coefficients could be quantized e.g., by using a uniform quantizer with a dead zone.

Local vs. Canonical Coordinate System for Displacements will now be discussed. The displacement field d(i) is defined in the same cartesian coordinate system as the input mesh. A possible optimization is to transform d(i) from this canonical coordinate system to a local coordinate system, which is defined by the normal to the subdivided mesh at each vertex.

A potential advantage of considering a local coordinate system for the displacements is the possibility to quantize more heavily the tangential components of the displacements compared to the normal component. The normal component of the displacement may have more significant impact on the reconstructed mesh quality than the two tangential components.

V-DMC encoder 200 and V-DMC decoder 300 may be configured to implement packing of wavelet coefficients. The following scheme is used to pack the wavelet coefficients into a 2D image:
Traverse the coefficients from low to high frequency.
For each coefficient, determine the index of the N×M pixel block (e.g., N=M=16) in which it should be stored following a raster order for blocks.
The position within the N×M pixel block is computed by using a Morton order to maximize locality.

Other packing schemes could be used (e.g., zigzag order, raster order). The V-DMC encoder 200 could explicitly signal in the bitstream the used packing scheme (e.g., atlas sequence parameters). This could be done at patch, patch group, tile, or sequence level.

V-DMC encoder 200 may be configured for displacement video encoding. The techniques may be agnostic of which video coding technology is used. When coding the displacement wavelet coefficients, a lossless approach may be used since the quantization is applied in a separate module. Another approach is to rely on the video encoder to compress the coefficients in a lossy manner and apply a quantization either in the original or transform domain.

There may be certain issues with V-DMC techniques. For purposes of illustration, reference is made to: Study of technologies for Video-based mesh coding, ISO/IEC JTC1/SC29/WG7, N00960, July 2024, referred to as “Updated Committee Draft.” For instance, the Updated Committee Draft includes signaling and parsing parameters for intra-meshpatch, merge meshpatch, and inter-meshpatch syntax elements.

The following provides an example list of issues that may be present. One or more example techniques described in this disclosure may be configured to address such issues. However, the example techniques should not be considered limited to addressing such issues.

A first issue may be that in case of inter and merge meshpatches the transform type is inherited from reference meshpatch, and lifting transform related parameter (params) may be written if lifting offset tool is disabled (lifting params) or enabled (lifting params+offsets) in ASPS (Atlas Sequence Parameter Set). It is however unclear how to check a value of reference meshpatch transform type without creating a parsing dependency.

A second issue may be that in case of inter and merge meshpatches, if lifting offset tool is disabled in ASPS, then lifting transform parameters may be written because lifting_main_param_flag is assumed 1 in this case.

A third issue may be that lifting offset params can only be signaled in intra meshpatch if mdu_transform_parameters_override_flag is signaled equal to 1 (also mdu_parameters_override_flag equal to 1), which can be simplified.

A fourth issue may be that if at SPS (sequence parameter set), the transform type equals none, then lifting offset flag may be disabled, and when at meshpatch level the transform type is overridden then lifting offset tool cannot be enabled (e.g., may not be able to enable). Also, if subdivision method is overridden at the meshpatch level, for example to mid/mid/loop, then lifting offset tool cannot be disabled at meshpatch level.

A fifth issue may be that to align the syntax of inter and merge meshpatches with intra meshpatches, there may be benefits in addressing parameter override dependencies.

The following describes example techniques that may address the above issues. For ease of explanation, the techniques are described with respect to addressing one of the issues. However, such description is meant for explanation purposes and should not be considered limiting. One of the example techniques may address multiple issues. In some cases, multiple techniques may together address one issue. In one or more examples, any one or more of the techniques described in this disclosure may be combined, or the example techniques may be performed separately.

For the first issue (e.g., issue one), as described above, in case of inter and merge meshpatches the transform type is inherited from reference meshpatch, and lifting transform related params will be written if lifting offset tool is disabled (lifting params) or enabled (lifting params+offsets) in ASPS. It is however unclear how to check value of reference meshpatch transform type without creating a parsing dependency.

As one example, Reference meshpatch has transform=lifting and current meshpatch has transform=none. In this case, transform type for current meshpatch is set equal to lifting and default lifting parameters may be written in bitstream, but this may not always occur causing errors.

In another example, if reference meshpatch has transform=none and current meshpatch has transform=lifting, transform type for current meshpatch will be set equal to none and lifting parameters will be written for current meshpatch.

One example solution is to have a restriction that merge and inter patches shall have the same transform type as the reference meshpatch, but this may introduce parsing dependency if reference patch may not be accessed in parsing process of current meshpatch.

A second solution may be to signal the transform type of the current meshpatch in inter and merge meshpatch syntax and check the transform type to write lifting related parameters or not. In the below, syntax elements related to the second solution are included as text between //Second Solution . . . Second Solution//

A third solution may be to combine the first and second solutions, meaning have a restriction that reference and current meshpatches have same transform type and signal the type to avoid a parsing dependency. In the below, syntax elements related to the second solution are included as text between //Third Solution . . . Third Solution//

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( asve_lod_patches_enable_flag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| //Second Solution | u(1) |
| mmdu_{—}transform_{—}method_{—}override_{—}flag[ tileID ][ patchIdx ] | |
| if( mmdu_transform_method_override_flag[ tileID ][ patchIdx ] ) | |
| { | |
| mmdu_{—}transform_{—}method[ tileID ][ patchIdx ] | u(3) |
| MergePatchTransformMethod[ tileID ][ patchIdx ] = | |
| mmdu_transform_method[ tileID ][ patchIdx ] | |
| } else { | |
| MergePatchTransformMethod[ tileID ][ patchIdx ] = | |
| AfpsTransformMethod (Note: global variable needs to be defined in AFPS as | |
| follows: AfpsTransformMethod = afve_transform_method) | |
| } | |
| if( MergePatchTransformMethod [ tileID ][ patchIdx ] | |
| == LINEAR_LIFTING && Second Solution// asve_lifting_offset_present_flag ) { | |
| mmdu_{—}lifting_{—}main_{—}param_{—}flag[ tileID ][ patchIdx ] | u(1) |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| if( //Second Solution MergePatchTransformMethod | |
| [ tileID ][ patchIdx ] == LINEAR_LIFTING && Second Solution// | |
| mmdu_lifting_main_param_flag[ tileID ][ patchIdx ] ){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_transform_method_override_flag[tileID][patchIdx] equal to 1 indicates mmdu_transform_method is present in a meshpatch with index patchIdx, in the current atlas tile, with tile ID equal to tileID. When mmdu_transform_method_override_flag[tileID][patchIdx] is not present, its value is inferred to be equal to 0.

mmdu_transform_method[tileID][patchIdx] indicates the identifier of the transform applied to the displacement associated with a meshpatch with index patchIdx, in the current atlas tile, with tile ID equal to tileID. When mmdu_transform_method[tileID][patchIdx] is not present, its value is inferred to be equal to afve_transform_method. Table describes the list of supported transforms and their relationship with mmdu_transform_method[tileID][patchIdx].

The following is an Example without transform override flag, with additions shown between //Third Solution . . . Third Solution//

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( asve_lod_patches_enable_flag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| //Third Solution mmdu_{—}transform_{—}method | u(3) |
| [ tileID ][ patchIdx ] | |
| MergePatchTransformMethod[ tileID ][ patchIdx ] = | |
| mmdu_transform_method[ tileID ][ patchIdx ] | |
| if( MergePatchTransformMethod [ tileID ][ patchIdx ] | |
| == LINEAR_LIFTING && Third Solution// asve_lifting_offset_present_flag ) { | |
| mmdu_{—}lifting_{—}main_{—}param_{—}flag[ tileID ][ patchIdx ] | u(1) |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| if( //Third Solution MergePatchTransformMethod | |
| [ tileID ][ patchIdx ] == LINEAR_LIFTING && Third Solution// | |
| mmdu_lifting_main_param_flag[ tileID ][ patchIdx ] ){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_transform_method [tileID][patchIdx] indicates the identifier of the transform applied to the displacement associated with a meshpatch with index patchIdx, in the current atlas tile, with tile ID equal to tileID. It is a conformance requirement that mmdu_transform_method [tileID][patchIdx] shall be equal to reference patch's transform method.

TABLE 3
Transform methods list

| asve_transform_method | |
|---|---|
| afve_transform_method | |
| mdu_transform_method | |
| //Add mmdu_transform_method | |
| Add// | Name of transform method |
| 0 | NONE |
| 1 | LINEAR_LIFTING |
| 2 . . . 7 | RESERVED |

And similar for inter meshpatch (text between //Inter-mesh . . . Inter-mesh//):

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !asve_displacement_id_present_flag ) { | |
| if( asve_lod_patches_enable_flag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| //Inter-mesh | u(1) |
| imdu_{—}transform_{—}method_{—}override_{—}flag[ tileID ][ patchIdx ] | |
| if( imdu_transform_method_override_flag[ tileID ][ patchIdx ] ) { | |
| imdu_{—}transform_{—}method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = | |
| AfpsTransformMethod (Note: global variable needs to be defined in AFPS as follows: | |
| AfpsTransformMethod = afve_transform_method) | |
| }Inter-mesh// | |
| } | |
| if( asve_displacement_id_present_flag \|\| ( asve_lod_patches_enable_flag == 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< asve_num_attribute_video; i++ ) { | |
| if( asve_attribute_subtexture_enabled_flag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ][ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| if(//Inter-mesh InterPatchTransformMethod [ tileID ][ patchIdx ] | |
| == LINEAR_LIFTING && Inter-mesh// asve_lifting_offset_present_flag ){ | |
| imdu_{—}lifting_{—}main_{—}param_{—}flag[ tileID ][ patchIdx ] | u(1) |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| if( //Inter-mesh InterPatchTransformMethod [ tileID ][ patchIdx ] | |
| == LINEAR_LIFTING && Inter-mesh// | |
| imdu_lifting_main_param_flag[ tileID ][ patchIdx ] ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_transform_method_override_flag[tileID][patchIdx] equal to 1 indicates imdu_transform_method is present in a meshpatch with index patchIdx, in the current atlas tile, with tile ID equal to tileID. When imdu_transform_method_override_flag[tileID][patchIdx] is not present, its value is inferred to be equal to 0.

imdu_transform_method [tileID][patchIdx] indicates the identifier of the transform applied to the displacement associated with a meshpatch with index patchIdx, in the current atlas tile, with tile ID equal to tileID. When imdu_transform_method [tileID][patchIdx] is not present, its value is inferred to be equal to afve_transform_method. Table describes the list of supported transforms and their relationship with imdu_transform_method [tileID][patchIdx].

Example without transform method override flag (added text shown between //Add . . . Add/

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !asve_displacement_id_present_flag ) { | |
| if( asve_lod patches_enable_flag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| //Add imdu_{—}transform_{—}method[ tileID ][ patchIdx ] | u(3) |
| InterPatchTransformMethod[ tileID ][ patchIdx ] = | |
| imdu_transform_method[ tileID ][ patchIdx ] Add// | |
| } | |
| if( asve_displacement_id_present_flag \|\| ( asve_lod_patches_enable_flag == 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< asve_num_attribute_video; i++ ) { | |
| if( asve_attribute_subtexture_enabled_flag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ][ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| if( //Add InterPatchTransformMethod [ tileID ][ patchIdx ] | |
| == LINEAR_LIFTING && Add// asve_lifting_offset_present_flag ){ | |
| imdu_{—}lifting_{—}main_{—}param_{—}flag[ tileID ][ patchIdx ] | u(1) |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| if( //Add InterPatchTransformMethod [ tileID ][ patchIdx ] | |
| == LINEAR_LIFTING && Add// | |
| imdu_lifting_main_param_flag[ tileID ][ patchIdx ] ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_transform_method [tileID][patchIdx] indicates the identifier of the transform applied to the displacement associated with a meshpatch with index patchIdx, in the current atlas tile, with tile ID equal to tileID. It is a conformance requirement that imdu_transform_method [tileID][patchIdx] shall be equal to reference patch's transform method.

TABLE 3
Transform methods list

| asve_transform_method | |
|---|---|
| afve_transform_method | |
| mdu_transform_method | |
| //Add mmdu_transform_method | |
| imdu_transform_method Add// | Name of transform method |
| 0 | NONE |
| 1 | LINEAR_LIFTING |
| 2 . . . 7 | RESERVED |

With respect to the second issue (e.g., issue two), transform parameters may be redundantly signaled when lifting offset tool is disabled. In case of inter and merge meshpatches, if lifting offset tool is disabled in ASPS, then lifting transform parameters may be written because lifting_main_param_flag is assumed 1 in this case.

One solution is to signal mmdu_lifting_main_param_flag (˜override flag) independently of AspsLiftingOffsetPresentFlag (added text shown between //Add . . . Add// and removed text shown between //Deleted . . . Deleted//) as follows:

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( AspsLodPatchesEnableFlag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| if( AspsLiftingOffsetPresentFlag ){ | |
| //Deleted mmdu_{—}lifting_{—}main_{—}param_{—}flag[ tileID ][ patchIdx ] | |
| Deleted// | |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| //Add mmdu_{—}lifting_{—}main_{—}param_{—}flag[ tileID ][ patchIdx ] Add// | u(1) |
| if( mmdu_lifting_main_param_flag[ tileID ][ patchIdx ] ){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !AspsDisplacementIdPresentFlag ) { | |
| if( AspsLodPatchesEnableFlag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< AspsAttributeVideoCount; i++ ) { | |
| if( AspsAttributeSubtextureEnabledFlag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ][ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| if( AspsLiftingOffsetPresentFlag ){ | |
| //Deleted imdu_{—}lifting_{—}main_{—}param_{—}flag[ tileID ][ patchIdx ] | |
| Deleted/ | |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| //Add imdu_{—}lifting_{—}main_{—}param_{—}flag[ tileID ][ patchIdx ] Add// | u(1) |
| if( imdu_lifting_main_param_flag[ tileID ][ patchIdx ] ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

The example solutions to the first and second issue can be combined. For example, the “lifting_main_param_flag” may also be considered a
“override_lifting_main_param_flag”.
mmdu_lifting_main_param_flag renamed as ‘mmdu_transform_parameters_override_flag’ and imdu_lifting_main_param_flag renamed as ‘imdu_transform_parameters_override_flag’ to align the naming with meshpatch data unit.

With respect to the third issue (e.g., issue three), separate signaling of lifting offset parameters in intra meshpatch may be possible. Lifting offset params may only be signaled in intra meshpatch if mdu_transform_parameters_override_flag is signaled equal to 1 (also mdu_parameters_override_flag equal to 1).

The example techniques may include signaling the lifting offsets independently of the mdu_transform_parameters_override_flag (shown with //Add . . . Add// for additional and shown with //Deleted . . . Deleted// for deletion). In this case the mdu_lifting_main_param_flag may no longer be needed. This may provide for signaling simplification, with reduction in signaling overhead.

| | Descriptor |
|---|---|
| meshpatch_data_unit( tileID, patchIdx ) { | |
| mdu_{—}submesh_{—}id[ tileID ][ patchIdx ] | ue(v) |
| if( AspsDisplacementIdPresentFlag ) { | |
| mdu_{—}displ_{—}id[ tileID ][ patchIdx ] | ue(v) |
| } else { | |
| if( AspsLodPatchesEnableFlag ) | |
| mdu_{—}lod_{—}idx[ tileID ][ patchIdx ] | ue(v) |
| if( mdu_lod_idx[ tileID ][ patchIdx ] == 0 ) | |
| mdu_{—}face_{—}count_{—}minus1[ tileID ][ patchIdx ] | ue(v) |
| mdu_{—}2d_{—}pos_{—}x[ tileID ][ patchIdx ] | ue(v) |
| mdu_{—}2d_{—}pos_{—}y[ tileID ][ patchIdx ] | ue(v) |
| mdu_{—}2d_{—}size_{—}x_{—}minus1[ tileID ][ patchIdx ] | ue(v) |
| mdu_{—}2d_{—}size_{—}y_{—}minus1[ tileID ][ patchIdx ] | ue(v) |
| } | |
| if( mdu_lod_idx[ tileID ][ patchIdx ] == 0 ) { | |
| mdu_{—}parameters_{—}override_{—}flag[ tileID ][ patchIdx ] | u(1) |
| if( mdu_parameters_override_flag[ tileID ][ patchIdx ] ){ | |
| mdu_{—}subdivision_{—}override_{—}flag[ tileID ][ patchIdx ] | u(1) |
| if( asve_quantization_parameters_present_flag && | |
| ( !mdu_subdivision_override_flag ) ) | |
| mdu_{—}quantization_{—}override_{—}flag[ tileID ][ patchIdx ] | u(1) |
| mdu_{—}transform_{—}method_{—}override_{—}flag[ tileID ][ patchIdx ] | u(1) |
| if ( ( !mdu_subdivision_override_flag ) && | |
| ( !mdu_transform_method_override_flag ) | |
| mdu_{—}transform_{—}parameters_{—}override_{—}flag[ tileID ][ patchIdx ] | u(1) |
| } | |
| if( mdu_subdivision_override_flag[ tileID ][ patchIdx ] ){ | |
| mdu_{—}subdivision_{—}iteration_{—}count | u(3) |
| PatchSubdivisionCount[ tileID ][ patchIdx ] = mdu_subdivision_iteration_count | |
| if( PatchSubdivisionCount[ tileID ][ patchIdx ] > 0) { | |
| mdu_{—}lod_{—}adaptive_{—}subdivision_{—}flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_{—}subdivision_{—}method[ tileID ][ patchIdx ][ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| } else { | |
| PatchSubdivisionCount[ tileID ][ patchIdx ] = AfpsSubdivisonCount | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| } | |
| if(mdu_quantization_override_flag[ tileID ][ patchIdx ]) | |
| vdmc_quantization_parameters(2, PatchSubdivisionCount[ tileID ][ patchIdx ] ) | |
| mdu_{—}displacement_{—}coordinate_{—}system[ tileID ][ patchIdx ] | u(1) |
| if(mdu_transform_method_override_flag[ tileID ][ patchIdx ]) | |
| mdu_{—}transform_{—}method[ tileID ][ patchIdx ] | u(3) |
| //Add | |
| if(mdu_transform_method[ tileID ][ patchIdx ]== LINEAR_LIFTING && | |
| AspsLiftingOffsetPresentFlag) { | |
| for( i = 0; i < PatchSubdivisionCount[ tileID ][ patchIdx ]; i++ ) { | |
| mdu_{—}lifting_{—}offset_{—}values_{—}num[ tileID ][ patchIdx ][ i ] | se(v) |
| mdu_{—}lifting_{—}offset_{—}values_{—}deno_{—}minus1[ tileID ][ patchIdx ][ i ] | ue(v) |
| } | |
| } Add// | |
| if(mdu_transform_method[ tileID ][ patchIdx ]== LINEAR_LIFTING && | |
| mdu_transform_parameters_override_flag[ tileID ][ patchIdx ]) { | |
| //Deleted if( AspsLiftingOffsetPresentFlag ) { | |
| mdu_{—}lifting_{—}main_{—}param_{—}flag[ tileID ][ patchIdx ] | u(1) |
| for( i = 0; i < PatchSubdivisionCount[ tileID ][ patchIdx ]; i++ ) { | |
| mdu_{—}lifting_{—}offset_{—}values_{—}num[ tileID ][ patchIdx ][ i ] | se(v) |
| mdu_{—}lifting_{—}offset_{—}values_{—}deno_{—}minus1[ tileID ][ patchIdx ][ i ] | ue(v) |
| } | |
| } | |
| if ( mdu_lifting_main_param_flag[ tileID ][ patchIdx ] ) { Deleted// | |
| vdmc_lifting_transform_parameters(2, | |
| PatchSubdivisionCount[ tileID ][ patchIdx ] ) | |
| //Deleted } Deleted// | |
| } | |
| } | |
| if( AspsDisplacementIdPresentFlag \|\| (AspsLodPatchesEnableFlag == 0 ) ) { | |
| vertexInfoCount = PatchSubdivisionCount[ tileID ][ patchIdx ] + 1 | |
| } else { | |
| vertexInfoCount = 1 | |
| } | |
| for( i = 0; i < vertexInfoCount; i++){ | |
| mdu_{—}block_{—}count_{—}minus1[ tileID ][ patchIdx ][ i ]; | u(v) |
| mdu_{—}last_{—}pos_{—}in_{—}block[ tileID ][ patchIdx ][ i ] | u(v) |
| } | |
| if( mdu_lod_idx[ tileID ][ patchIdx ] == 0 ) { | |
| for( i=0; i< AspsAttributeVideoCount; i++ ){ | |
| if( AspsAttributeSubtextureEnabledFlag[ i ] ){ | |
| mdu_{—}attributes_{—}2d_{—}pos_{—}x[ tileID ][ patchIdx ][ i ] | ue(v) |
| mdu_{—}attributes_{—}2d_{—}pos_{—}y[ tileID ][ patchIdx ][ i ] | ue(v) |
| mdu_{—}attributes_{—}2d_{—}size_{—}x_{—}minus1[ tileID ][ patchIdx ][ i ] | ue(v) |
| mdu_{—}attributes_{—}2d_{—}size_{—}y_{—}minus1[ tileID ][ patchIdx ][ i ] | ue(v) |
| } | |
| } | |
| smIdx = SubmeshIDToIndex[ mdu_submesh_id[ tileID ][ patchIdx ] ] | |
| if( afve_projection_texcoord_present_flag[ smIdx ] ) | |
| texture_projection_information( tileID, patchIdx ) | |
| } | |
| } | |

With respect to the fourth issue (i.e., issue four), signaling of lifting offset tool enable flag may be at meshpatch level. Lifting offset tool may only be enabled in ASPS.

The problem may be that if at SPS, the transform type=none then lifting offset flag will be disabled, and when at meshpatch level the transform type is overridden then lifting offset tool cannot be enabled.

If subdivision method is overridden at the meshpatch level, for example to mid/mid/loop, then lifting offset tool cannot be disabled at meshpatch level.

There may be better locations in the syntax structure to signal the enabling flag. For instance, providing a functionality to enable lifting offset tool at meshpatch level may address the above-mentioned issue and is a more appropriate location since lifting offsets are derived at patch level.

Signaling lifting offset enable flag at meshpatch data unit (MPDU), inter-meshpatch data unit (IMPDU) and merge-meshpatch data unit (MMPDU) shown between //Add . . . Add//

| | Descriptor |
|---|---|
| meshpatch_data_unit( tileID, patchIdx ) { | |
| mdu_{—}submesh_{—}id[ tileID ][ patchIdx ] | ue(v) |
| if( asve_displacement_id_present_flag ) { | |
| mdu_{—}displ_{—}id[ tileID ][ patchIdx ] | ue(v) |
| } else { | |
| if( asve_lod_patches_enable_flag ) | |
| mdu_{—}lod_{—}idx[ tileID ][ patchIdx ] | ue(v) |
| if( mdu_lod_idx[ tileID ][ patchIdx ] == 0 ) | |
| mdu_{—}face_{—}count_{—}minus1[ tileID ][ patchIdx ] | ue(v) |
| mdu_{—}2d_{—}pos_{—}x[ tileID ][ patchIdx ] | ue(v) |
| mdu_{—}2d_{—}pos_{—}y[ tileID ][ patchIdx ] | ue(v) |
| mdu_{—}2d_{—}size_{—}x_{—}minus1[ tileID ][ patchIdx ] | ue(v) |
| mdu_{—}2d_{—}size_{—}y_{—}minus1[ tileID ][ patchIdx ] | ue(v) |
| } | |
| if( mdu_lod_idx[ tileID ][ patchIdx ] == 0 ) { | |
| mdu_{—}parameters_{—}override_{—}flag[ tileID ][ patchIdx ] | u(1) |
| if( mdu_parameters_override_flag[ tileID ][ patchIdx ] ){ | |
| mdu_{—}subdivision_{—}override_{—}flag[ tileID ][ patchIdx ] | u(1) |
| if( asve_quantization_parameters_present_flag && | |
| ( !mdu_subdivision_override_flag ) ) | |
| mdu_{—}quantization_{—}override_{—}flag[ tileID ][ patchIdx ] | u(1) |
| mdu_{—}transform_{—}method_{—}override_{—}flag[ tileID ][ patchIdx ] | u(1) |
| if ( ( !mdu_subdivision_override_flag ) && | |
| ( !mdu_transform_method_override_flag ) | |
| mdu_{—}transform_{—}parameters_{—}override_{—}flag[ tileID ][ patchIdx ] | u(1) |
| } | |
| if( mdu_subdivision_override_flag[ tileID ][ patchIdx ] ){ | |
| mdu_{—}subdivision_{—}iteration_{—}count | u(3) |
| PatchSubdivisionCount[ tileID ][ patchIdx ] = mdu_subdivision_iteration_count | |
| if( PatchSubdivisionCount[ tileID ][ patchIdx ] > 0) { | |
| mdu_{—}lod_{—}adaptive_{—}subdivision_{—}flag[ tileID ][ patchIdx ] | u(1) |
| } | |
| for( i = 0; i < PatchSubdivisionCount[ tileID ][ patchIdx ]; i++) { | |
| if( mdu_lod_adaptive_subdivision_flag == 1 \|\| i == 0 ) { | |
| mdu_{—}subdivision_{—}method[ tileID ][ patchIdx ] [ i ] | u(3) |
| } else { | |
| mdu_subdivision_method[ tileID ][ patchIdx ][ i ] = | |
| mdu_subdivision_method[ tileID ][ patchIdx ][ 0 ] | |
| } | |
| PatchSubdivisionMethod[ tileID ][ patchIdx ][ i ] = | |
| mdu_subdivision_method[ i ] | |
| } | |
| } else { | |
| PatchSubdivisionCount[ tileID ][ patchIdx ] = AfpsSubdivisonCount | |
| for( i = 0; i < PatchSubdivisionCount[ tileID ][ patchIdx ]; i++ ){ | |
| PatchSubdivisionMethod[ tileID ][ patchIdx ][ i ] = | |
| AfpsSubdivisionMethod[ i ] | |
| } | |
| } | |
| if(mdu_quantization_override_flag[ tileID ][ patchIdx ]) | |
| vdmc_quantization_parameters(2, PatchSubdivisionCount[ tileID ][ patchIdx ] ) | |
| mdu_{—}displacement_{—}coordinate_{—}system[ tileID ][ patchIdx ] | u(1) |
| if(mdu_transform_method_override_flag[ tileID ][ patchIdx ]) | |
| mdu_{—}transform_{—}method[ tileID ][ patchIdx ] | u(3) |
| //Add if(mdu_transform_method[ tileID ][ patchIdx ]== LINEAR_LIFTING ) | |
| { | |
| mdu_{—}lifting_{—}offset_{—}flag[ tileID ][ patchIdx ] Add// | u(1) |
| if(mdu_transform_method[ tileID ][ patchIdx ]== LINEAR_LIFTING && | |
| mdu_transform_parameters_override_flag[ tileID ][ patchIdx ]) { | |
| if( //Add mdu_lifting_offset_flag[ tileID ][ patchIdx ] Add//) { | |
| mdu_{—}lifting_{—}main_{—}param_{—}flag[ tileID ][ patchIdx ] | u(1) |
| for( i = 0; i < PatchSubdivisionCount[ tileID ][ patchIdx ]; i++ ) { | |
| mdu_{—}lifting_{—}offset_{—}values_{—}num[ tileID ][ patchIdx ][ i ] | se(v) |
| mdu_{—}lifting_{—}offset_{—}values_{—}deno_{—}minus1[ tileID ][ patchIdx ][ i ] | ue(v) |
| } | |
| } | |
| if ( mdu_lifting_main_param_flag[ tileID ][ patchIdx ] ) { | |
| vdmc_lifting_transform_parameters(2, | |
| PatchSubdivisionCount[ tileID ][ patchIdx ] ) | |
| } | |
| } | |
| } | |
| if( asve_displacement_id_present_flag \|\| (asve_lod_patches_enable_flag == 0 ) ) { | |
| vertexInfoCount = PatchSubdivisionCount[ tileID ][ patchIdx ] + 1 | |
| } else { | |
| vertexInfoCount = 1 | |
| } | |
| for( i = 0; i < vertexInfoCount; i++){ | |
| mdu_{—}block_{—}count_{—}minus1[ tileID ][ patchIdx ][ i ]; | u(v) |
| mdu_{—}last_{—}pos_{—}in_{—}block[ tileID ][ patchIdx ][ i ] | u(v |
| } | |
| if( mdu_lod_idx[ tileID ][ patchIdx ] == 0 ) { | |
| for( i=0; i< asve_num_attribute_video; i++ ){ | |
| if( asve_attribute_subtexture_enabled_flag[ i ] ){ | |
| mdu_{—}attributes_{—}2d_{—}pos_{—}x[ tileID ][ patchIdx ][ i ] | ue(v) |
| mdu_{—}attributes_{—}2d_{—}pos_{—}y[ tileID ][ patchIdx ][ i ] | ue(v) |
| mdu_{—}attributes_{—}2d_{—}size_{—}x_{—}minus1[ tileID ][ patchIdx ][ i ] | ue(v) |
| mdu_{—}attributes_{—}2d_{—}size_{—}y_{—}minus1[ tileID ][ patchIdx ][ i ] | ue(v) |
| } | |
| } | |
| smIdx = SubmeshIDToIndex[ mdu_submesh_id[ tileID ][ patchIdx ] ] | |
| if( afve_projection_texcoord_present_flag[ smIdx ] ) | |
| texture_projection_information( tileID, patchIdx ) | |
| } | |
| } | |

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( asve_lod_patches_enable_flag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| //Add mmdu_{—}lifting_{—}offset_{—}flag[ tileID ][ patchIdx ] | u(1) |
| if( mmdu_lifting_offset_flag [ tileID ][ patchIdx ] Add//){ | |
| mmdu_{—}lifting_{—}main_{—}param_{—}flag[ tileID ][ patchIdx ] | u(1) |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| if( mmdu_lifting_main_param_flag[ tileID ][ patchIdx ] ){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !asve_displacement_id_present_flag ) { | |
| if( asve_lod_patches_enable_flag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu 2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| } | |
| if( asve_displacement_id_present_flag \|\| ( asve_lod_patches_enable_flag == 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< asve_num_attribute_video; i++ ) { | |
| if( asve_attribute_subtexture_enabled_flag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ][ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| //Add imdu_{—}lifting_{—}offset_{—}flag[ tileID ][ patchIdx ] | u(1) |
| if( imdu_lifting_offset_flag [ tileID ][ patchIdx ]){ Add// | |
| imdu_{—}lifting_{—}main_{—}param_{—}flag[ tileID ][ patchIdx ] | u(1) |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| if( imdu_lifting_main_param_flag[ tileID ][ patchIdx ] ){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

mdu_lifting_offset_flag[tileID][patchIdx] equal to 1 indicates that the lifting offset was applied to the displacement associated with a meshpatch with index patchIdx, in the current atlas tile, with tile ID equal to tileID. mdu_lifting_offset_flag [tileID][patchIdx] equal to 0 indicates that the lifting offset was not applied to the displacement associated with a meshpatch with index patchIdx, in the current atlas tile, with tile ID equal to tileID.

mmdu_lifting_offset_flag[tileID][patchIdx] equal to 1 indicates that the lifting offset was applied to the displacement associated with a meshpatch with index patchIdx, in the current atlas tile, with tile ID equal to tileID. mmdu_lifting_offset_flag [tileID][patchIdx] equal to 0 indicates that the lifting offset was not applied to the displacement associated with a meshpatch with index patchIdx, in the current atlas tile, with tile ID equal to tileID.

imdu_lifting_offset_flag[tileID][patchIdx] equal to 1 indicates that the lifting offset was applied to the displacement associated with a meshpatch with index patchIdx, in the current atlas tile, with tile ID equal to tileID. imdu_lifting_offset_flag [tileID][patchIdx] equal to 0 indicates that the lifting offset was not applied to the displacement associated with a meshpatch with index patchIdx, in the current atlas tile, with tile ID equal to tileID.

The following describes signaling lifting offset enable flag at MPDU and restriction for IMPDU and MMPDU

The specification text looks identical to the above example, expect the semantics changes are bolded and italicized:

mmdu_lifting_offset_flag[tileID][patchIdx] equal to 1 indicates that the lifting offset was applied to the displacement associated with a meshpatch with index patchIdx, in the current atlas tile, with tile ID equal to tileID. mmdu_lifting_offset_flag [tileID][patchIdx] equal to 0 indicates that the lifting offset was not applied to the displacement associated with a meshpatch with index patchIdx, in the current atlas tile, with tile ID equal to tileID. It is a conformance requirement that mmdu_lifting_offset_flag[tileID][patchIdx] shall be equal to reference patch's lifting offset flag.

imdu_lifting_offset_flag[tileID][patchIdx] equal to 1 indicates that the lifting offset was applied to the displacement associated with a meshpatch with index patchIdx, in the current atlas tile, with tile ID equal to tileID. imdu_lifting_offset_flag [tileID][patchIdx] equal to 0 indicates that the lifting offset was not applied to the displacement associated with a meshpatch with index patchIdx, in the current atlas tile, with tile ID equal to tileID. It is a conformance requirement that imdu_lifting_offset_flag[tileID][patchIdx] shall be equal to reference patch's lifting offset flag.

With respect to the fifth issue (e.g., issue five), there may be overriding of dependencies in inter and merge meshpatches

To align the syntax of inter and merge meshpatches with intra meshpatches, similar parameter override dependencies are proposed as adopted from MPEG m69003.

In merge meshpatch syntax the number of subdivisions can be overridden by mmdu_subdivision_override_flag. In this case, it may be possible to override the lifting transform parameters as well, shown with //Add . . . Add// where adding and //Deleted . . . Deleted// where deleting.

There may be cases to override the quantization parameters if number of subdivisions is overridden. If subdivisions are overridden, then there may be a possibility to include quantization parameters.

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( AspsLodPatchesEnableFlag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| if( AspsLiftingOffsetPresentFlag ){ | |
| mmdu_{—}lifting_{—}main_{—}param_{—}flag[ tileID ][ patchIdx ] | u(1) |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| if( mmdu_lifting_main_param_flag[ tileID ][ patchIdx ] //Add \|\| | |
| mmdu_subdivision_override_flag ){ Add// | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

Alternatively, if mmdu_lifting_main_param_flag is signaled independently from AspsLiftingOffsetPresentFlag (combination with issue two):

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( AspsLodPatchesEnableFlag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| if( AspsLiftingOffsetPresentFlag ){ | |
| //Deleted mmdu_{—}lifting_{—}main_{—}param_{—}flag[ tileID ][ patchIdx ] | |
| Deleted// | |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| //Add mmdu_{—}lifting_{—}main_{—}param_{—}flag[ tileID ][ patchIdx ] Add/ | u(1) |
| if( mmdu_lifting_main_param_flag[ tileID ][ patchIdx ]//Add \|\| | |
| mmdu_subdivision_override_flag Add// ){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

In inter meshpatch syntax the number of subdivisions can be overridden by imdu_subdivision_override_flag. In this case, overriding the lifting transform parameters may be performed as well.

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !AspsDisplacementIdPresentFlag ) { | |
| if( AspsLodPatchesEnableFlag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< AspsAttributeVideoCount; i++ ) { | |
| if( AspsAttributeSubtextureEnabledFlag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ] [ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| if( AspsLiftingOffsetPresentFlag ){ | |
| imdu_{—}lifting_{—}main_{—}param_{—}flag[ tileID ][ patchIdx ] | u(1) |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| if( imdu_lifting_main_param_flag[ tileID ][ patchIdx ] //Add\|\| | |
| imdu_subdivision_override_flag){Add// | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

For inter meshpatch, the combination with issue two may also be possible.

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !AspsDisplacementIdPresentFlag ) { | |
| if( AspsLodPatchesEnableFlag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| } | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< AspsAttributeVideoCount; i++ ) { | |
| if( AspsAttributeSubtextureEnabledFlag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ][ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| if( AspsLiftingOffsetPresentFlag ){ | |
| //Deleted imdu_{—}lifting_{—}main_{—}param_{—}flag[ tileID ][ patchIdx ] | |
| Deleted// | |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| //Add imdu_{—}lifting_{—}main_{—}param_{—}flag[ tileID ][ patchIdx ] Add// | u(1) |
| if( imdu_lifting_main_param_flag[ tileID ][ patchIdx ]//Add \|\| | |
| imdu_subdivision_override_flag[ tileID ][ patchIdx ]Add//){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

Similarly, if the mmdu_transform_method_override_flag or imdu_transform_method_override_flag is introduced (combination with issue one), then lifting transform parameters may be signaled as follows:

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( asve_lod_patches_enable_flag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| //Add | u(1) |
| mmdu_{—}transform_{—}method_{—}override_{—}flag[ tileID ][ patchIdx ] | |
| if( mmdu_transform_method_override_flag[ tileID ][ patchIdx ] ) { | |
| mmdu_{—}transform_{—}method[ tileID ][ patchIdx ] | u(3) |
| MergePatchTransformMethod[ tileID ][ patchIdx ] = | |
| mmdu_transform_method[ tileID ][ patchIdx ] | |
| } else { | |
| MergePatchTransformMethod[ tileID ][ patchIdx ] = | |
| AfpsTransformMethod (Note: global variable needs to be defined in AFPS as follows: | |
| AfpsTransformMethod = afve_transform_method) | |
| } | |
| if( MergePatchTransformMethod [ tileID ][ patchIdx ] | |
| == LINEAR_LIFTING && Add// asve_lifting_offset_present_flag ) { | |
| mmdu_{—}lifting_{—}main_{—}param_{—}flag[ tileID ][ patchIdx ] | u(1) |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| if( //Add MergePatchTransformMethod [ tileID ][ patchIdx ] | |
| == LINEAR_LIFTING && (mmdu_lifting_main_param_flag[ tileID ][ patchIdx ] \|\| | |
| mmdu_subdivision_override_flag \|\| mmdu_transform_method_override_flag) ) Add// { | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !asve_displacement_id_present_flag ) { | |
| if( asve_lod_patches_enable_flag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| //Add imdu_{—}transform_{—}method_{—}override_{—}flag[ tileID ][ patchIdx ] | u(1) |
| if( imdu_transform_method_override_flag[ tileID ][ patchIdx ] ) { | |
| imdu_{—}transform_{—}method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = | |
| AfpsTransformMethod (Note: global variable needs to be defined in AFPS as follows: | |
| AfpsTransformMethod = afve_transform_method) | |
| } Add// | |
| } | |
| if( asve_displacement_id_present_flag \|\| ( asve_lod_patches_enable_flag == 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< asve_num_attribute_video; i++ ) { | |
| if( asve_attribute_subtexture_enabled_flag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ][ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| if( //Add InterPatchTransformMethod [ tileID ][ patchIdx ] | |
| == LINEAR_LIFTING && Add// asve_lifting_offset_present_flag ){ | |
| imdu_{—}lifting_{—}main_{—}param_{—}flag[ tileID ][ patchIdx ] | u(1) |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| if( //Add InterPatchTransformMethod [ tileID ][ patchIdx ] | |
| == LINEAR_LIFTING && (imdu_lifting_main_param_flag[ tileID ][ patchIdx ] \|\| | |
| imdu_subdivision_override_flag \|\| imdu_transform_method_override_flag) ) Add//{ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

The following describes examples of combination of issue five with issue one (restriction on transform type)

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( asve_lod_patches_enable_flag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| //Add1 mmdu_{—}transform_{—}method [ tileID ][ patchIdx ] | u(3) |
| MergePatchTransformMethod[ tileID ][ patchIdx ] = | |
| mmdu_transform_method[ tileID ][ patchIdx ] | |
| if( MergePatchTransformMethod [ tileID ][ patchIdx ] | |
| == LINEAR_LIFTING && Add1// asve_lifting_offset_present_flag ) { | |
| mmdu_{—}lifting_{—}main_{—}param_{—}flag[ tileID ][ patchIdx ] | u(1) |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| if( //Add1 MergePatchTransformMethod [ tileID ][ patchIdx ] | |
| == LINEAR_LIFTING && Add1// | |
| (mmdu_lifting_main_param_flag[ tileID ][ patchIdx ] //Add5\|\| | |
| mmdu_subdivision_override_flag) Add5//){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !asve_displacement_id_present_flag ) { | |
| if( asve_lod_patches_enable_flag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| //Add1 imdu_{—}transform_{—}method[ tileID ][ patchIdx ] | u(3) |
| InterPatchTransformMethod[ tileID ][ patchIdx ] = | |
| imdu_transform_method[ tileID ][ patchIdx ] Add1// | |
| } | |
| if( asve_displacement_id_present_flag \|\| ( asve_lod_patches_enable_flag == 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< asve_num_attribute_video; i++ ) { | |
| if( asve_attribute_subtexture_enabled_flag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ][ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| if(//Add1 InterPatchTransformMethod [ tileID ][ patchIdx ] | |
| == LINEAR_LIFTING && Add1// asve_lifting_offset_present_flag ){ | |
| imdu_{—}lifting_{—}main_{—}param_{—}flag[ tileID ][ patchIdx ] | u(1) |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| if( //Add1 InterPatchTransformMethod [ tileID ][ patchIdx ] | |
| == LINEAR_LIFTING && | |
| Add1// (imdu_lifting_main_param_flag[ tileID ][ patchIdx ] //Add5 \|\| | |
| imdu_subdivision_override_flag)Add5//){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

The above, text between //Add5 . . . Add5// are issue five solution, and text between //Add1 . . . Add1// are issue one solution with restriction.

mmdu_transform_method [tileID][patchIdx] indicates the identifier of the transform applied to the displacement associated with a meshpatch with index patchIdx, in the current atlas tile, with tile ID equal to tileID. It is a conformance requirement that mmdu_transform_method [tileID][patchIdx] shall be equal to reference patch's transform method.

imdu_transform_method [tileID][patchIdx] indicates the identifier of the transform applied to the displacement associated with a meshpatch with index patchIdx, in the current atlas tile, with tile ID equal to tileID. It is a conformance requirement that imdu_transform_method [tileID][patchIdx] shall be equal to reference patch's transform method.

The following includes combined solution of all issues for Inter and Merge patches with restriction. In the following, //Add1 . . . Add1// is for issue one, /Add2 . . . Add2// is for issue two, //Add4 . . . Add4// is for issue four, and //Add5 . . . Add5// is for issue five.

MERGE patch with restrictions on transform method and lifting offset flag:

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( asve_lod_patches_enable_flag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| //Add1 mmdu_{—}transform_{—}method [ tileID ][ patchIdx ] | u(3) |
| MergePatchTransformMethod[ tileID ][ patchIdx ] = | |
| mmdu_transform_method[ tileID ][ patchIdx ] Add1// | |
| //Add4 | |
| if(MergePatchTransformMethod[tileID ][ patchIdx ]==LINEAR_LIFTING ) | |
| mmdu_{—}lifting_{—}offset_{—}flag[ tileID ][ patchIdx ] Add4// | u(1) |
| if(//Add1 MergePatchTransformMethod [ tileID ][ patchIdx ] | |
| == LINEAR_LIFTING && Add1// //Add4 | |
| mmdu_lifting_offset_flag[ tileID ][ patchIdx ] Add4// ) { | |
| // Deleted | |
| mmdu_{—}lifting_{—}main_{—}param_{—}flag[ tileID ][ patchIdx ] Deleted// | |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| //Add1 if( MergePatchTransformMethod [ tileID ][ patchIdx ] | |
| == LINEAR_LIFTING) Add1// | |
| //Add2 mdu_{—}lifting_{—}main_{—}param_{—}flag[ tileID ][ patchIdx ] | u(1) |
| Add2// | |
| if( //Add1MergePatchTransformMethod [ tileID ][ patchIdx ] | |
| == LINEAR_LIFTING && Add1/ | |
| (mmdu_lifting_main_param_flag[ tileID ][ patchIdx ] //Add5\|\| | |
| mmdu_subdivision_override_flag Add5//){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_transform_method [tileID][patchIdx] indicates the identifier of the transform applied to the displacement associated with a meshpatch with index patchIdx, in the current atlas tile, with tile ID equal to tileID. It is a conformance requirement that mmdu_transform_method [tileID][patchIdx] shall be equal to reference patch's transform method.

mmdu_lifting_offset_flag[tileID][patchIdx] equal to 1 indicates that the lifting offset was applied to the displacement associated with a meshpatch with index patchIdx, in the current atlas tile, with tile ID equal to tileID. mmdu_lifting_offset_flag [tileID][patchIdx] equal to 0 indicates that the lifting offset was not applied to the displacement associated with a meshpatch with index patchIdx, in the current atlas tile, with tile ID equal to tileID. It is a conformance requirement that mmdu_lifting_offset_flag[tileID][patchIdx] shall be equal to reference patch's lifting offset flag.

INTER patch with restrictions on transform method and lifting offset flag:

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !asve_displacement_id_present_flag ) { | |
| if( asve_lod_patches_enable_flag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| //Add1 imdu_{—}transform_{—}method[ tileID ][ patchIdx ] | u(3) |
| InterPatchTransformMethod[ tileID ][ patchIdx ] = | |
| imdu_transform_method[ tileID ][ patchIdx ] Add1// | |
| } | |
| if( asve_displacement_id_present_flag \|\| ( asve_lod_patches_enable_flag == 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< asve_num_attribute_video; i++ ) { | |
| if( asve_attribute_subtexture_enabled_flag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ][ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| //Add4 if(InterPatchTransformMethod | |
| [ tileID ][ patchIdx ]== LINEAR_LIFTING ) | |
| imdu_{—}lifting_{—}offset_{—}flag[ tileID ][ patchIdx ] Add4// | u(1) |
| //Add1 if(InterPatchTransformMethod [ tileID ][ patchIdx ] | |
| == LINEAR_LIFTING && Add1// //Add4 imdu_lifting_offset_flag Add4//){ | |
| //Deleted | |
| imdu_{—}lifting_{—}main_{—}param_{—}flag[ tileID ][ patchIdx ] Deleted// | |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| If//Add1( InterPatchTransformMethod [ tileID ][ patchIdx ] | |
| == LINEAR_LIFTING Add1/) | |
| //Add2 | u(1) |
| imdu_{—}lifting_{—}main_{—}param_{—}flag[ tileID ][ patchIdx ] Add2// | |
| if( //Add1 InterPatchTransformMethod [ tileID ][ patchIdx ] | |
| == LINEAR_LIFTING && Add1// | |
| //Add5 (imdu_lifting_main_param_flag[ tileID ][ patchIdx ] \|\| | |
| imdu_subdivision_override_flag) Add5//){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_transform_method [tileID][patchIdx] indicates the identifier of the transform applied to the displacement associated with a meshpatch with index patchIdx, in the current atlas tile, with tile ID equal to tileID. It is a conformance requirement that imdu_transform_method [tileID][patchIdx] shall be equal to reference patch's transform method.

imdu_lifting_offset_flag[tileID][patchIdx] equal to 1 indicates that the lifting offset was applied to the displacement associated with a meshpatch with index patchIdx, in the current atlas tile, with tile ID equal to tileID. imdu_lifting_offset_flag [tileID][patchIdx] equal to 0 indicates that the lifting offset was not applied to the displacement associated with a meshpatch with index patchIdx, in the current atlas tile, with tile ID equal to tileID. It is a conformance requirement that imdu_lifting_offset_flag[tileID][patchIdx] shall be equal to reference patch's lifting offset flag.

The following describes combined solution of all issues for Inter and Merge patches with flexibility. In the following, //Add1 . . . Add1// is for issue one,/Add2 . . . Add2// is for issue two, //Add4 . . . Add4// is for issue four, and //Add5 . . . Add5// is for issue five.

MERGE patch with flexibility on transform method and lifting offset flag:

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( asve_lod_patches_enable_flag ) | |
| mmdu_{—}lod_{—}idx[ tileID ][ patchIdx ] | ue(v) |
| if( mmdu_lod_idx[ tileID ][ patchIdx ] == 0 ) { | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| //Add1 | u(1) |
| mmdu_{—}transform_{—}method_{—}override_{—}flag[ tileID ][ patchIdx ] | |
| if( mmdu_transform_method_override_flag[ tileID ][ patchIdx ] ) { | |
| mmdu_{—}transform_{—}method[ tileID ][ patchIdx ] | u(3) |
| MergePatchTransformMethod[ tileID ][ patchIdx ] = | |
| mmdu_transform_method[ tileID ][ patchIdx ] | |
| } else { | |
| MergePatchTransformMethod[ tileID ][ patchIdx ] = | |
| AfpsTransformMethod (Note: global variable needs to be defined in AFPS as follows: | |
| AfpsTransformMethod = afve_transform_method) | |
| } Add1// | |
| //Add4if(MergePatchTransformMethod | |
| [ tileID ][ patchIdx ]== LINEAR_LIFTING ) | |
| mmdu_{—}lifting_{—}offset_{—}flag[ tileID ][ patchIdx ] Add4// | u(1) |
| if(//Add1 MergePatchTransformMethod [ tileID ][ patchIdx ] | |
| == LINEAR_LIFTING && Add1// //Add4 | |
| mmdu_lifting_offset_flag[ tileID ][ patchIdx ] Add4//) { | |
| //Deleted | |
| mmdu_{—}lifting_{—}main_{—}param_{—}flag[ tileID ][ patchIdx ] Deleted// | |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| if(//Add1 MergePatchTransformMethod [ tileID ][ patchIdx ] | |
| == LINEAR_LIFTING Add1//) | |
| //Add2 | u(1) |
| mmdu_{—}lifting_{—}main_{—}param_{—}flag[ tileID ][ patchIdx ] Add2// | |
| if( //Add1 MergePatchTransformMethod [ tileID ][ patchIdx ] | |
| == LINEAR_LIFTING && Add1// //Add5 | |
| (mmdu_lifting_main_param_flag[ tileID ][ patchIdx ] \|\| | |
| mmdu_subdivision_override_flag \|\| mmdu_transform_method_override_flag) Add5//){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

mmdu_transform_method_override_flag[tileID][patchIdx] equal to 1 indicates mmdu_transform_method is present in a meshpatch with index patchIdx, in the current atlas tile, with tile ID equal to tileID. When mmdu_transform_method_override_flag[tileID][patchIdx] is not present, its value is inferred to be equal to 0.

mmdu_transform_method [tileID][patchIdx] indicates the identifier of the transform applied to the displacement associated with a meshpatch with index patchIdx, in the current atlas tile, with tile ID equal to tileID. When mmdu_transform_method [tileID][patchIdx] is not present, its value is inferred to be equal to afve_transform_method. Table describes the list of supported transforms and their relationship with mmdu_transform_method [tileID][patchIdx].

mmdu_lifting_offset_flag[tileID][patchIdx] equal to 1 indicates that the lifting offset was applied to the displacement associated with a meshpatch with index patchIdx, in the current atlas tile, with tile ID equal to tileID. mmdu_lifting_offset_flag [tileID][patchIdx] equal to 0 indicates that the lifting offset was not applied to the displacement associated with a meshpatch with index patchIdx, in the current atlas tile, with tile ID equal to tileID.

INTER patch with flexibility on transform method and lifting offset flag:

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !asve_displacement_id_present_flag ) { | |
| if( asve_lod_patches_enable_flag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| //Add1 | u(1) |
| imdu_{—}transform_{—}method_{—}override_{—}flag[ tileID ][ patchIdx ] | |
| if( imdu_transform_method_override_flag[ tileID ][ patchIdx ] ) { | |
| imdu_{—}transform_{—}method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = | |
| AfpsTransformMethod (Note: global variable needs to be defined in AFPS as follows: | |
| AfpsTransformMethod = afve_transform_method) | |
| } Add1// | |
| } | |
| if( asve_displacement_id_present_flag \|\| ( asve_lod_patches_enable_flag == 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< asve_num_attribute_video; i++ ) { | |
| if( asve_attribute_subtexture_enabled_flag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ] [ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| //Add4 if(InterPatchTransformMethod | |
| [ tileID ][ patchIdx ]== LINEAR_LIFTING ) { | |
| imdu_{—}lifting_{—}offset_{—}flag[ tileID ][ patchIdx ] Add4// | u(1) |
| if( //Add1 InterPatchTransformMethod [ tileID ][ patchIdx ] | |
| == LINEAR_LIFTING && Add1// //Add4 imdu_lifting_offset_flag Add4//){ | |
| //Deleted | |
| imdu_{—}lifting_{—}main_{—}param_{—}flag[ tileID ][ patchIdx ] Deleted// | |
| for( i= 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| if( //Add1 InterPatchTransformMethod [ tileID ][ patchIdx ] | |
| == LINEAR_LIFTING) Add1// | |
| //Add2 | u(1) |
| imdu_{—}lifting_{—}main_{—}param_{—}flag[ tileID ][ patchIdx ] Add2// | |
| if( //Add1 InterPatchTransformMethod [ tileID ][ patchIdx ] | |
| == LINEAR_LIFTING && Add1// //Add5 | |
| (imdu_lifting_main_param_flag[ tileID ][ patchIdx ] \|\| imdu_subdivision_override_flag | |
| \|\| imdu_transform_method_override_flag))Add5//{ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

imdu_transform_method_override_flag[tileID][patchIdx] equal to 1 indicates imdu_transform_method is present in a meshpatch with index patchIdx, in the current atlas tile, with tile ID equal to tileID. When imdu_transform_method_override_flag[tileID][patchIdx] is not present, its value is inferred to be equal to 0.

imdu_transform_method [tileID][patchIdx] indicates the identifier of the transform applied to the displacement associated with a meshpatch with index patchIdx, in the current atlas tile, with tile ID equal to tileID. When imdu_transform_method [tileID][patchIdx] is not present, its value is inferred to be equal to afve_transform_method. Table describes the list of supported transforms and their relationship with imdu_transform_method [tileID][patchIdx].

imdu_lifting_offset_flag[tileID][patchIdx] equal to 1 indicates that the lifting offset was applied to the displacement associated with a meshpatch with index patchIdx, in the current atlas tile, with tile ID equal to tileID. imdu_lifting_offset_flag [tileID][patchIdx] equal to 0 indicates that the lifting offset was not applied to the displacement associated with a meshpatch with index patchIdx, in the current atlas tile, with tile ID equal to tileID.

Combined solution of all issues (as shown above) with top-level override flag

In the example above, two override flags are present: imdu_subdivision_override_flag and imdu_transform_method_override_flag. As for intra meshpatch, a top-level override flag is introduced in the merge and inter meshpatches: imdu_parameters_override_flag and mmdu_parameters_override_flag. These flags have the following semantics:

mmdu_parameters_override_flag[tileID][patchIdx] equal to 1 indicates the parameters mmdu_subdivision_override_flag, mmdu_transform_method_override_flag, are present in a merge meshpatch with index patchIdx, in the current atlas tile, with tile ID equal to tileID.

imdu_parameters_override_flag[tileID][patchIdx] equal to 1 indicates the parameters imdu_subdivision_override_flag, imdu_transform_method_override_flag, are present in a merge meshpatch with index patchIdx, in the current atlas tile, with tile ID equal to tileID.

Additional override flags may be introduced in the merge and inter meshpatch syntax, for example:
mmdu_quantization_override_flag, mmdu_transform_parameters_override_flag, imdu_quantization_override_flag, imdu_transform_parameters_override_flag

When override flags are not present then their values are inferred to be equal to 0.

The following illustrates the merge meshpatch syntax (//MergeMeshpatch . . . Mergemeshpatch//). Designations for other issues has been included below, but not called out separately.

| | Descriptor |
|---|---|
| merge_meshpatch_data_unit( tileID, patchIdx ) { | |
| if( NumRefIdxActive ) | |
| mmdu_{—}ref_{—}index[ tileID ][ patchIdx ] | ue(v) |
| mmdu_{—}patch_{—}index[ tileID ][ patchIdx ] | se(v) |
| if( asve_lod_patches_enable_flag ) | |
| mmdu_{—}lod_{—}idx[ tileID ][ patchIdx ] | ue(v) |
| if( mmdu_lod_idx[ tileID ][ patchIdx ] == 0 ) { | |
| //MergeMeshpatch | u(1) |
| mmdu_{—}parameters_{—}override_{—}flag[ tileID ][ patchIdx ] | |
| if( mmdu_parameters_override_flag[ tileID ][ patchIdx ] ) { | |
| MergeMeshpatch// | |
| mmdu_{—}subdivision_{—}override_{—}flag[ tileID ][ patchIdx ] | u(1) |
| if( mmdu_subdivision_override_flag[ tileID ][ patchIdx ]){ | |
| mmdu_{—}subdivision_{—}iteration_{—}count[ tileID ][ patchIdx ] | u(3) |
| MergePatchSubvisionCount[ tileID ][ patchIdx ] = | |
| mmdu_subdivision_iteration_count[ tileID ][ patchIdx ] | |
| } else { | |
| MergePatchSubvisionCount[ tileID ][ patchIdx ] = | |
| AfpsSubdivisionCount | |
| } | |
| mmdu_{—}transform_{—}method_{—}override_{—}flag[ tileID ][ patchIdx ] | u(1) |
| if( | |
| mmdu_transform_method_override_flag[ tileID ][ patchIdx ] ) { | |
| mmdu_{—}transform_{—}method[ tileID ][ patchIdx ] | u(3) |
| MergePatchTransformMethod[ tileID ][ patchIdx ] | |
| = mmdu_transform_method[ tileID ][ patchIdx ] | |
| } else { | |
| MergePatchTransformMethod[ tileID ][ patchIdx ] | |
| = AfpsTransformMethod (Note: global variable needs to be defined in AFPS as | |
| follows: AfpsTransformMethod = afve_transform_method) | |
| } | |
| } | |
| if(MergePatchTransformMethod | |
| [ tileID ][ patchIdx ]== LINEAR_LIFTING ) | |
| mmdu_{—}lifting_{—}offset_{—}flag[ tileID ][ patchIdx ] | u(1) |
| if( MergePatchTransformMethod [ tileID ][ patchIdx ] | |
| == LINEAR_LIFTING && mmdu_lifting_offset_flag[ tileID ][ patchIdx ] ) { | |
| //Deleted | |
| mmdu_{—}lifting_{—}main_{—}param_{—}flag[ tileID ][ patchIdx ] Deleted// | |
| for( i = 0; i < MergePatchSubdivisionCount[ tileID ][ patchIdx ]; i++ ) { | |
| mmdu_{—}lifting_{—}offset_{—}delta_{—}values_{—}num[ tileID ][ patchIdx ][ i ] | se(v) |
| mmdu_{—}lifting_{—}offset_{—}delta_{—}values_{—}deno[ tileID ][ patchIdx ][ i ] | se(v) |
| } | |
| } | |
| if(MergePatchTransformMethod [ tileID ][ patchIdx ] | |
| == LINEAR_LIFTING) | |
| mmdu_{—}lifting_{—}main_{—}param_{—}flag[ tileID ][ patchIdx ] | u(1) |
| if( MergePatchTransformMethod [ tileID ][ patchIdx ] | |
| == LINEAR_LIFTING && (mmdu_lifting_main_param_flag[ tileID ][ patchIdx ] \|\| | |
| mmdu_subdivision_override_flag \|\| mmdu_transform_method_override_flag) ){ | |
| vdmc_lifting_transform_parameters( 2, | |
| MergePatchSubdivisionCount[ tileID ][ patchIdx ] ) | |
| } | |
| if( asve_projection_texcoord_enable_flag ){ | |
| mmdu_{—}texture_{—}projection_{—}present_{—}flag[ tileID ][ patchIdx ] | u(1) |
| if( mmdu_texture_projection_present_flag[ tileID ][ patchIdx ] ) | |
| texture_projection_merge_information( tileID, patchIdx ) | |
| } | |
| } | |
| } | |
| } | |

And the following are syntax modifications for inter meshpatch (//Intermeshpatch . . . Intermeshpatch//). Designations for other issues has been included below, but not called out separately.

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !asve_displacement_id_present_flag ) { | |
| if( asve_lod_patches_enable_flag ) | |
| imdu_{—}lod_{—}idx[ tileID ][ patchIdx ] | ue(v) |
| if( imdu_lod_idx[ tileID ][ patchIdx ] == 0 ) | |
| imdu_{—}delta_{—}face_{—}count_{—}minus1[ tileID ][ patchIdx ] | se(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| // Intermeshpatch | u(1) |
| imdu_{—}parameters_{—}override_{—}flag[ tileID ][ patchIdx ] | |
| if( imdu_parameters_override_flag[ tileID ][ patchIdx ] ) { | |
| Intermeshpatch// | |
| imdu_{—}subdivision_{—}override_{—}flag[ tileID ][ patchIdx ] | u(1) |
| if( imdu_subdivision_override_flag[ tileID ][ patchIdx ] ){ | |
| imdu_{—}subdivision_{—}iteration_{—}count[ tileID ][ patchIdx ] | U(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisonCount | |
| imdu_{—}transform_{—}method_{—}override_{—}flag[ tileID ][ patchIdx ] | u(1) |
| if( | |
| imdu_transform_method_override_flag[ tileID ][ patchIdx ] ) { | |
| imdu_{—}transform_{—}method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = | |
| AfpsTransformMethod (Note: global variable needs to be defined in AFPS as follows: | |
| AfpsTransformMethod = afve_transform_method) | |
| } | |
| } | |
| } | |
| if( asve_displacement_id_present_flag \|\| ( asve_lod_patches_enable_flag == 0 | |
| ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ]; | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { | |
| for(i=0; i< asve_num_attribute_video; i++ ) { | |
| if( asve_attribute_subtexture_enabled_flag[ i ] ) { | |
| imdu_{—}attributes_{—}2d_{—}delta_{—}pos_{—}x[ tileID ][ patchIdx ][ i ] | se(v) |
| imdu_{—}attributes_{—}2d_{—}delta_{—}pos_{—}y[ tileID ] [ patchIdx ][ i ] | se(v) |
| imdu_{—}attributes_{—}2d_{—}delta_{—}size_{—}x[ tileID ][ patchIdx ][ i ] | se(v) |
| imdu_{—}attributes_{—}2d_{—}delta_{—}size_{—}y[ tileID ][ patchIdx ][ i ] | se(v) |
| } | |
| } | |
| if(InterPatchTransformMethod | |
| [ tileID ][ patchIdx ]== LINEAR_LIFTING ) { | |
| imdu_{—}lifting_{—}offset_{—}flag[ tileID ][ patchIdx ] | u(1) |
| if( InterPatchTransformMethod [ tileID ][ patchIdx ] | |
| == LINEAR_LIFTING && imdu_lifting_offset_flag ){ | |
| //Deleted | |
| imdu_{—}lifting_{—}main_{—}param_{—}flag[ tileID ][ patchIdx ] Deleted// | |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| if( InterPatchTransformMethod [ tileID ][ patchIdx ] | |
| == LINEAR_LIFTING) | |
| imdu_{—}lifting_{—}main_{—}param_{—}flag[ tileID ][ patchIdx ] | u(1) |
| if( InterPatchTransformMethod [ tileID ][ patchIdx ] | |
| == LINEAR_LIFTING && (imdu_lifting_main_param_flag[ tileID ][ patchIdx ] \|\| | |
| imdu_subdivision_override_flag \|\| imdu_transform_method_override_flag)){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection_{—}present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| } | |

The following describes inter meshpatch design. In the V-DMC specification text draft “Technologies for Video-based mesh coding,” ISO/IEC JTC1/SC29/WG7, N01099, January 2025 (FDIS target), it is unclear in what cases the inter meshpatch is beneficial compared with intra and merge meshpatches. It is assumed that the merge meshpatch is used when the number of vertices in the current meshpatch is identical to the number of vertices in the reference meshpatch as well as the number of subdivision iterations, displacement transform (lifting or none, etc.), subdivision schemes, quantization, etc. Delta coding of some tool parameters is allowed in this case, for example, lifting offset tool parameters, directional lifting parameters, inverse quantization offset parameters, etc. The intra meshpatch is assumed to be used when, for example, the number of subdivision iterations is modified, transform type is modified, subdivision methods are modified, etc. The intra meshpatch allows the signaling of essentially a new configuration for the current meshpatch, for example, different number of subdivision iterations.

However, for the inter meshpatch, it is not clearly defined in what cases it can be used. Therefore, in this disclosure it is proposed to have an encoder conformance restriction that the number of subdivision iterations may be (e.g., shall be) smaller than the number of subdivision iterations of the reference meshpatch. Alternatively, the number of subdivision iterations may be (e.g., shall be) smaller than or equal to the number of subdivision iterations of the reference meshpatch.

The following is the proposed syntax and semantics for the inter meshpatch based on techniques described in “Technologies for Video-based mesh coding,” ISO/IEC JTC1/SC29/WG7, N01099, January 2025. As above, in the following, added text is shown between //Add . . . Add// and removed text is shown between //Deleted . . . Deleted//).

| | Descriptor |
|---|---|
| inter_meshpatch_data_unit( tileID, patchIdx ) { | |
| if( NumRefIdxActive ) | |
| imdu_{—}ref_{—}index[ tileID ][ patchIdx ] | ue(v) |
| imdu_{—}patch_{—}index[ tileID ][ patchIdx ] | se(v) |
| if( !AspsDisplacementIdPresentFlag ) { | |
| if( AspsLodPatchesEnableFlag ) | |
| imdu_{—}lod_{—}idx[ tileID ][ patchIdx ] | ue(v) |
| imdu_{—}2d_{—}delta_{—}pos_{—}x[ tileID ][ patchIdx ] | se(v) |
| imdu_{—}2d_{—}delta_{—}pos_{—}y[ tileID ][ patchIdx ] | se(v) |
| imdu_{—}2d_{—}delta_{—}size_{—}x[ tileID ][ patchIdx ] | se(v) |
| imdu_{—}2d_{—}delta_{—}size_{—}y[ tileID ][ patchIdx ] | se(v) |
| } | |
| if( imdu_lod_idx[ tileID ][ patchIdx ] == 0 ) { | |
| imdu_{—}subdivision_{—}iteration_{—}count_{—}present_{—}flag[ tileID ][ patchIdx ] | u(1) |
| if( imdu_subdivision_iteration_count_present_flag[ tileID ][ patchIdx ] ){ | |
| imdu_{—}subdivision_{—}iteration_{—}count[ tileID ][ patchIdx ] | u(3) |
| InterPatchSubdivisionCount[ tileID ][ patchIdx ] = | |
| imdu_subdivision_iteration_count[ tileID ][ patchIdx ] | |
| }else | |
| InterPatchSubdivisionCount[ tileID ][ patchIdx ] = AfpsSubdivisionCount | |
| if( AspsInvQuantOffsetPresentFlag ) { | |
| imdu_{—}inverse_{—}quantization_{—}offset_{—}enable_{—}flag[ tileID ][ patchIdx ] | u(1) |
| if( imdu_inverse_quantization_offset_enable_flag ) { | |
| for( i = 0; i < InterPatchSubdivisionCount[ tileID ][ patchIdx ]; i++ ) { | |
| for( j = 0; j < AspsDispComponents; j++ ) { | |
| for( k = 0; k < 3; k++ ) { | |
| imdu_{—}inverse_{—}quantization_{—}offset_{—}sign[ tileID ][ patchIdx ][ i ][ j ][ k ] | u(1) |
| imdu_{—}inverse_{—}quantization_{—}offset_{—}value_{—}log2_{—}prec1_{—}delta[ tileID ][ patchIdx ][ i ][ | se(v) |
| j ][ k ] | |
| imdu_{—}inverse_{—}quantization_{—}offset_{—}value_{—}log2_{—}prec2_{—}delta[ tileID ][ patchIdx ][ i ][ | se(v) |
| j ][ k ] | |
| } | |
| } | |
| } | |
| } | |
| } | |
| if( InterPatchSubdivisionCount[ tileID ][ patchIdx ] != 0 ) | |
| imdu_{—}transform_{—}parameters_{—}present_{—}flag[ tileID ][ patchIdx ] | u(1) |
| imdu_{—}transform_{—}method_{—}present_{—}flag[ tileID ][ patchIdx ] | u(1) |
| if( imdu_transform_method_present_flag[ tileID ][ patchIdx ] ) { | |
| imdu_{—}transform_{—}method[ tileID ][ patchIdx ] | u(3) |
| InterPatchTransformMethod[ tileID ][ patchIdx ] = | |
| imdu_transform_method[ tileID ][ patchIdx ] | |
| } else { | |
| InterPatchTransformMethod[ tileID ][ patchIdx ] = AfpsTransformMethod | |
| } | |
| //Deleted} | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ] | se(v) |
| imdu_{—}delta_{—}last_{—}pos_{—}in_{—}block[ tileID ][ patchIdx ][ i ] | se(v) |
| } | |
| if ( imdu_lod_idx[ tileID ][ patchIdx ] == 0 ) { //Deleted | |
| if( InterPatchTransformMethod[ tileID ][ patchIdx ] == LINEAR_LIFTING & | |
| & | |
| AspsLiftingOffsetPresentFlag ){ | |
| imdu_{—}lifting_{—}offset_{—}present_{—}flag[ tileID ][ patchIdx ] | u(1) |
| if( imdu_lifting_offset_present_flag[ tileID ][ patchIdx ] ) { | |
| for( i = 0; i < InterPatchSubdivisionCount[ tileID ][ patchIdx ]; i++ ) { | |
| imdu_{—}lifting_{—}offset_{—}delta_{—}values_{—}num[ tileID ][ patchIdx ][ i ] | se(v) |
| imdu_{—}lifting_{—}offset_{—}delta_{—}values_{—}deno[ tileID ][ patchIdx ][ i ] | se(v) |
| } | |
| } | |
| } | |
| if( InterPatchTransformMethod[ tileID ][ patchIdx ] == LINEAR_LIFTING & | |
| & | |
| AspsDirectionalLiftingPresentFlag ) { | |
| imdu_{—}directional_{—}lifting_{—}present_{—}flag[ tileID ][ patchIdx ] ) { | u(1) |
| if( imdu_directional_lifting_present_flag[ tileID ][ patchIdx ] ) { | |
| imdu_{—}directional_{—}lifting_{—}delta_{—}mean_{—}num[ tileID ][ patchIdx ] | se(v) |
| imdu_{—}directional_{—}lifting_{—}delta_{—}mean_{—}deno[ tileID ][ patchIdx ] | se(v) |
| imdu_{—}directional_{—}lifting_{—}delta_{—}std_{—}num[ tileID ][ patchIdx ] | se(v) |
| imdu_{—}directional_{—}lifting_{—}delta_{—}std_{—}deno[ tileID ][ patchIdx ] | se(v) |
| } | |
| } | |
| if( InterPatchTransformMethod[ tileID ][ patchIdx ] == LINEAR_LIFTING & | |
| & imdu_transform_parameters_present_flag[ tileID ][ patchIdx ] //Deleted \|\| | |
| imdu_subdivision_iteration_count_present_flag[ tileID ][ patchIdx ] \|\| | |
| imdu_transform_method_present_flag[ tileID ][ patchIdx ] ) Deleted// //Add && | |
| InterPatchSubdivisionCount[ tileID ][ patchIdx ] != 0 Add//){ | |
| vdmc_lifting_transform_parameters( 2, | |
| InterPatchSubdivisionCount[ tileID ][ patchIdx ] ) | |
| } | |
| if( asve_projection_texcoord_enable_flag ) | |
| imdu_{—}texture_{—}projection present_{—}flag[ tileID ][ patchIdx ] | u(1) |
| if( imdu_texture_projection_present_flag[ tileID ][ patchIdx ] ) | |
| texture_projection_inter_information( tileID, patchIdx ) | |
| } | |
| //Add | |
| if( AspsDisplacementIdPresentFlag \|\| ( AspsLodPatchesEnableFlag == 0 ) ) { | |
| vertexInfoCount = InterPatchSubdivisionCount[ tileID ][ patchIdx ] + 1 | |
| } else { | |
| vertexInfoCount = 1 | |
| } | |
| for( i = 0; i < vertexInfoCount; i++){ | |
| imdu_{—}delta_{—}block_{—}count[ tileID ][ patchIdx ][ i ] | |
| imdu_{—}delta_{—}last_{—}pos_{—}in_{—}block[ tileID ][ patchIdx ][ i ] | |
| } Add// | |
| } | |

imdu_subdivision_iteration_count_present_flag[tileID][patchIdx] equal to 1 indicates imdu_subdivision_iteration_count [tileID][patchIdx] is present in a meshpatch with index patchIdx, in the current atlas tile, with tile ID equal to tileID. imdu_subdivision_iteration_count_present_flag[tileID][patchIdx] equal to 0 indicates imdu_subdivision_iteration_count [tileID][patchIdx] is not present in a meshpatch with index patchIdx, in the current atlas tile, with tile ID equal to tileID.

As one example, imdu_subdivision_iteration_count [tileID][patchIdx] indicates the number of iterations used for the subdivision in a meshpatch with index patchIdx, in the current atlas tile, with tile ID equal to tileID. When imdu_subdivision_iteration_count [tileID][patchIdx] is not present its value is inferred to be equal to afve_subdivision_iteration_count. In some examples, it is a requirement of bitstream conformance that the value of imdu_subdivision_iteration_count [tileID][patchIdx] shall be smaller than to the corresponding value in the reference meshpatch.

As another example, imdu_subdivision_iteration_count [tileID][patchIdx] indicates the number of iterations used for the subdivision in a meshpatch with index patchIdx, in the current atlas tile, with tile ID equal to tileID. When imdu_subdivision_iteration_count [tileID][patchIdx] is not present its value is inferred to be equal to afve_subdivision_iteration_count. In some examples, it is a requirement of bitstream conformance that the value of imdu_subdivision_iteration_count [tileID][patchIdx] shall be smaller than or equal to the corresponding value in the reference meshpatch.

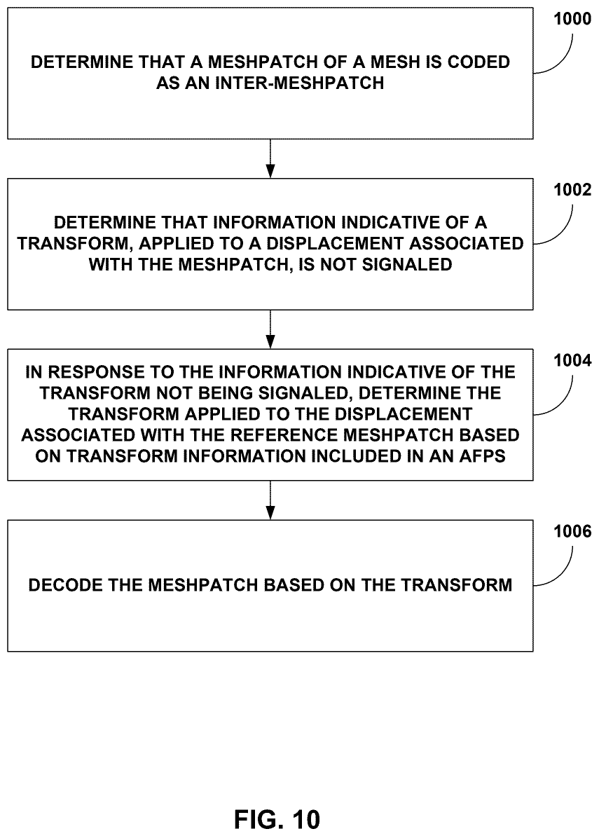

FIG. 10 is a flowchart illustrating an example method of operation. The example of FIG. 10 is described with respect to V-DMC decoder 300 for ease of description. For example, one or more memories of V-DMC decoder 300 may store mesh data, and processing circuitry of V-DMC decoder 300 may be coupled to the one or more memories, and the processing circuitry of V-DMC decoder 300 may be configured to perform the example techniques of FIG. 10.

The processing circuitry of V-DMC decoder 300 may determine that a meshpatch of a mesh is coded as an inter-meshpatch (1000). For example, the processing circuitry may receive syntax elements or other information from which the processing circuitry may determine that the meshpatch is an inter-meshpatch. Other techniques to determine that the meshpatch is an inter-meshpatch is possible.

The processing circuitry of V-DMC decoder 300 may determine that information indicative of a transform, applied to a displacement associated with the meshpatch, is not signaled (1002). An example, to determine that information indicative of the transform is not signaled, the processing circuitry may parse a flag indicating that the information indicative of the transform is not signaled.

For instance, the processing circuitry may parse the imdu_transform_method_override_flag[tileID][patchIdx]. In one example, imdu_transform_method_override_flag[tileID][patchIdx] equal to 1 indicates imdu_transform_method is present in a meshpatch with index patchIdx, in the current atlas tile, with tile ID equal to tileID. When imdu_transform_method_override_flag[tileID][patchIdx] is not present, its value is inferred to be equal to 0.

Accordingly, if imdu_transform_method_override_flag is true, the processing circuitry may determine that information indicative of the transform is signaled (e.g., imdu_transform_method is signaled). If imdu_transform_method_override_flag is false, the processing circuitry may determine information indicative of the transform, applied to the displacement associated with the meshpatch, is not signaled. The imdu_transform_method corresponds to the transform method used for the meshpatch.

In response to the information indicative of the transform not being signaled, the processing circuitry may determine the transform, applied to the first displacement associated with the first meshpatch, based on transform information included in an atlas frame parameter set (AFPS) (1004). For example, if imdu_transform_method_override_flag is false, meaning information indicative of the transform is not signaled, then the processing circuitry may determine that InterPatchTransformMethod[tileID][patchIdx]=AfpsTransformMethod. In this example, AfpsTransformMethod is included in the AFPS, and InterPatchTransformMethod is the transform method for the meshpatch. In this manner, to determine the transform applied to the displacement, the processing circuitry may bypass access to memory that stores the information indicative of the transform applied to the displacement associated with a reference meshpatch for the meshpatch. That is, the processing circuitry may not need access memory with slow access time to determine the transform associated with the reference meshpatch, and can instead access the information from the AFPS.

The processing circuitry of V-DMC may decode the meshpatch based on the transform (1006). For example, the processing circuitry may perform operations similar to those described for FIG. 7 and FIG. 8.

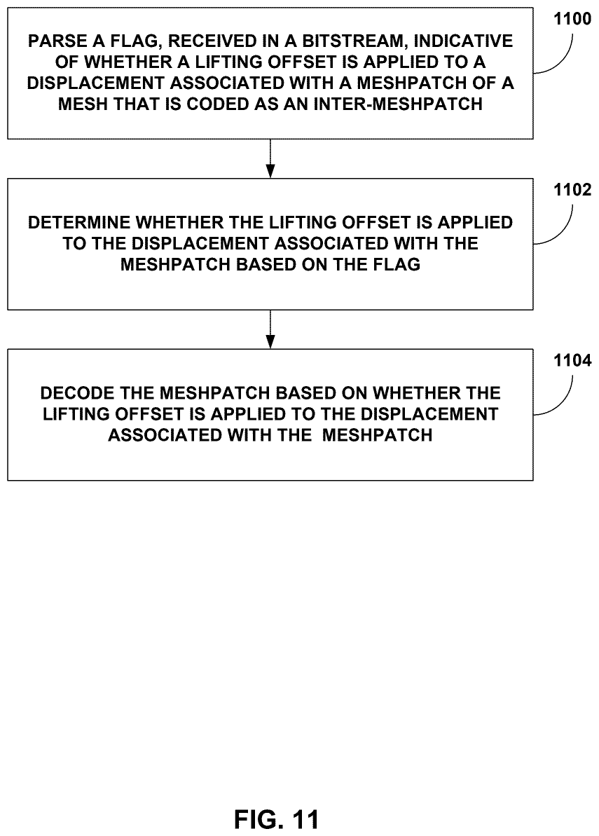

FIG. 11 is another flowchart illustrating an example method of operation. The example of FIG. 11 is described with respect to V-DMC decoder 300 for ease of description. For example, one or more memories of V-DMC decoder 300 may store mesh data, and processing circuitry of V-DMC decoder 300 may be coupled to the one or more memories, and the processing circuitry of V-DMC decoder 300 may be configured to perform the example techniques of FIG. 11.

The processing circuitry of V-DMC decoder 300 may parse a flag, received in a bitstream, indicative of whether a lifting offset is applied to a displacement associated with a meshpatch of a mesh that is coded as an inter-meshpatch (1100). As one example, the flag may the imdu_lifting_offset_flag[title ID][patchIdx]. The imdu_lifting_offset_flag indicates if lifting offset is applied to meshpatch. In one or more examples, imdu_lifting_offset_flag[tileID][patchIdx] equal to 1 indicates that the lifting offset was applied to the displacement associated with a meshpatch with index patchIdx, in the current atlas tile, with tile ID equal to tileID. In one or more examples, imdu_lifting_offset_flag[tileID][patchIdx] equal to 0 indicates that the lifting offset was not applied to the displacement associated with a meshpatch with index patchIdx, in the current atlas tile, with tile ID equal to tileID.

The processing circuitry of V-DMC 300 may determine whether the lifting offset is applied to the displacement associated with the meshpatch based on the flag (1102). For example, the processing circuitry may determine whether the lifting offset is applied based on the value of imdu_lifting_offset_flag. The processing circuitry of V-DMC 300 may decode the meshpatch based on whether the lifting offset is applied to the displacement associated with the meshpatch (1104). For example, the processing circuitry may perform operations similar to those described for FIG. 7 and FIG. 8.

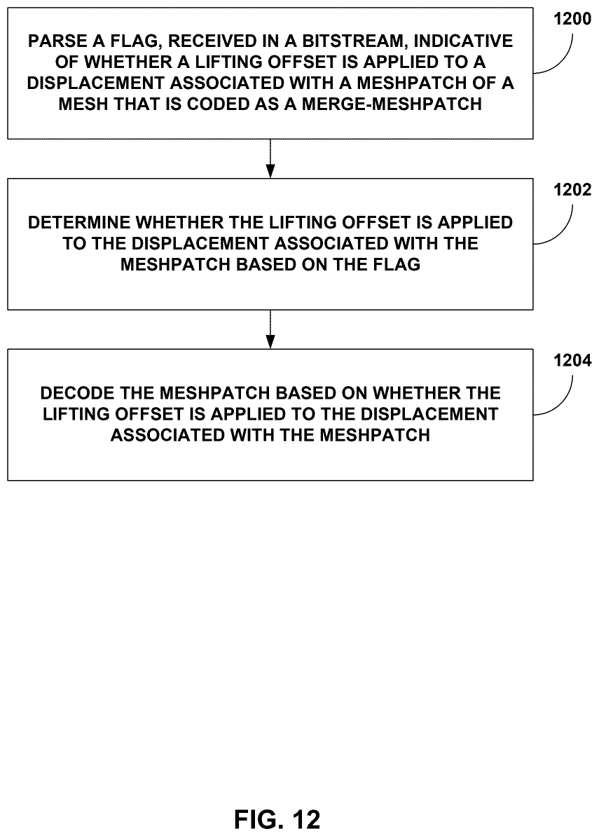

FIG. 12 is another flowchart illustrating an example method of operation. The example of FIG. 12 is described with respect to V-DMC decoder 300 for ease of description. For example, one or more memories of V-DMC decoder 300 may store mesh data, and processing circuitry of V-DMC decoder 300 may be coupled to the one or more memories, and the processing circuitry of V-DMC decoder 300 may be configured to perform the example techniques of FIG. 12.

The processing circuitry of V-DMC decoder 300 may parse a flag, received in a bitstream, indicative of whether a lifting offset is applied to a displacement associated with a meshpatch of a mesh that is coded as a merge-meshpatch (1200). As one example, the flag may the mmdu_lifting_offset_flag[titleID][patchIdx]. The mmdu_lifting_offset_flag may be indicative of if lifting offset was applied to the meshpatch or not (e.g., for a merge-meshpatch). In one or more examples, mmdu_lifting_offset_flag[tileID][patchIdx] equal to 1 indicates that the lifting offset was applied to the displacement associated with a meshpatch with index patchIdx, in the current atlas tile, with tile ID equal to tileID. In one or more examples, mmdu_lifting_offset_flag[tileID][patchIdx] equal to 0 indicates that the lifting offset was not applied to the displacement associated with a meshpatch with index patchIdx, in the current atlas tile, with tile ID equal to tileID.

In some examples, the flag indicative of whether the lifting offset is applied has same value as a flag, associated with a reference meshpatch for the meshpatch, indicative of whether the lifting offset is applied to the reference meshpatch. That is, the value of mmdu_lifting_offset_flag for the meshpatch should be equal to the value of mmdu_lifting_offset_flag for the reference meshpatch.

The processing circuitry of V-DMC decoder 300 may determine whether the lifting offset is applied to the displacement associated with the meshpatch based on the flag (1202). For example, the processing circuitry may determine whether the lifting offset is applied based on the value of mmdu_lifting_offset_flag. The processing circuitry of V-DMC decoder 300 may decode the meshpatch based on whether the lifting offset is applied to the displacement associated with the meshpatch (1204). For example, the processing circuitry may perform operations similar to those described for FIG. 7 and FIG. 8.

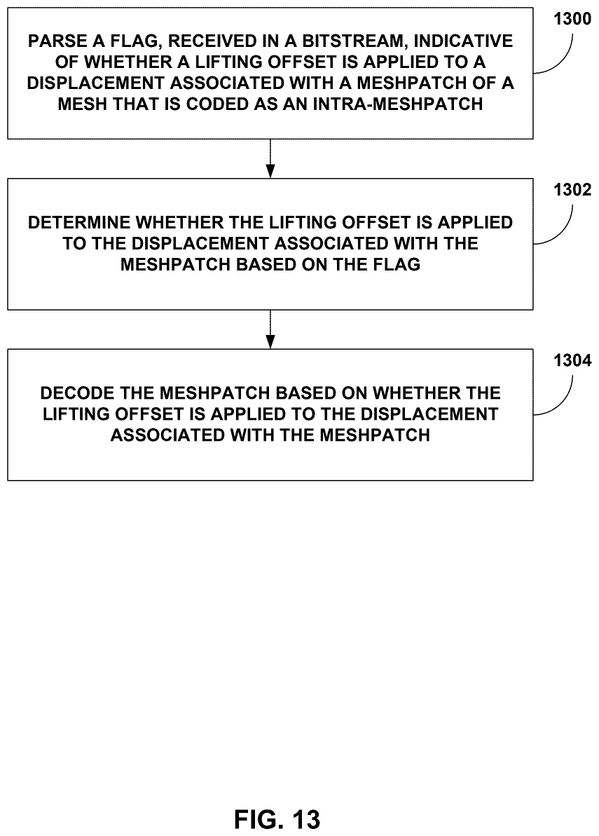

FIG. 13 is another flowchart illustrating an example method of operation. The example of FIG. 13 is described with respect to V-DMC decoder 300 for ease of description. For example, one or more memories of V-DMC decoder 300 may store mesh data, and processing circuitry of V-DMC decoder 300 may be coupled to the one or more memories, and the processing circuitry of V-DMC decoder 300 may be configured to perform the example techniques of FIG. 13.

The processing circuitry of V-DMC decoder 300 may parse a flag, received in a bitstream, indicative of whether a lifting offset is applied to a displacement associated with a meshpatch of a mesh that is coded as an intra-meshpatch (1300). As one example, the flag may be the mdu_lifting_offset_flag[titleID][patchIdx]. The mdu_lifting_offset_flag may be indicative of if lifting offset was applied to the meshpatch or not (e.g., for an intra-meshpatch). In one or more examples, mdu_lifting_offset_flag[tileID][patchIdx] equal to 1 indicates that the lifting offset was applied to the displacement associated with a meshpatch with index patchIdx, in the current atlas tile, with tile ID equal to tileID. In one or more examples, mdu_lifting_offset_flag[tileID][patchIdx] equal to 0 indicates that the lifting offset was not applied to the displacement associated with a meshpatch with index patchIdx, in the current atlas tile, with tile ID equal to tileID.

The processing circuitry of V-DMC decoder 300 may determine whether the lifting offset is applied to the displacement associated with the meshpatch based on the flag (1302). For example, the processing circuitry may determine whether the lifting offset is applied based on the value of mdu_lifting_offset_flag. The processing circuitry of V-DMC 300 may decode the meshpatch based on whether the lifting offset is applied to the displacement associated with the meshpatch (1304). For example, the processing circuitry may perform operations similar to those described for FIG. 7 and FIG. 8.

Examples of the various aspects of this disclosure may be used individually or in any combination. Additional aspects of the disclosure are detailed in numbered clauses below.

Clause 1. A method of decoding meshpatch data, the method comprising determining that a first meshpatch of a first mesh is coded as an inter-meshpatch, determining that information indicative of a transform, applied to a first displacement associated with the first meshpatch, is not signaled, in response to the information indicative of the transform not being signaled, determining the transform, applied to the first displacement associated with the first meshpatch, based on transform information included in an atlas frame parameter set (AFPS), and decoding the first meshpatch based on the transform.

Clause 2. The method of Clause 1, wherein determining the transform applied to the first displacement comprises bypassing access to memory that stores the information indicative of the transform applied to a displacement associated with a reference meshpatch for the first meshpatch.

Clause 3. The method of any of Clauses 1-2, wherein determining that information indicative of the transform is not signaled comprises parsing a flag indicating that the information indicative of the transform is not signaled.

Clause 4. The method of any of Clauses 1-3, wherein a value of a number of subdivision iterations for the first meshpatch is less than or equal to a number of subdivisions of a reference meshpatch for the first meshpatch.

Clause 5. The method of any of Clauses 1-4, further comprising parsing a flag, received in a bitstream, indicative of whether a lifting offset is applied to a second displacement associated with a second meshpatch of a second mesh that is coded as the inter-meshpatch, determining whether the lifting offset is applied to the second displacement associated with the second meshpatch based on the flag, and decoding the second meshpatch based on whether the lifting offset is applied to the second displacement associated with the second meshpatch.

Clause 6. The method of any of Clauses 1-5, further comprising parsing a flag, received in a bitstream, indicative of whether a lifting offset is applied to a second displacement associated with a second meshpatch of a second mesh that is coded as a merge-meshpatch, determining whether the lifting offset is applied to the second displacement associated with the second meshpatch based on the flag, and decoding the second meshpatch based on whether the lifting offset is applied to the second displacement associated with the second meshpatch.

Clause 7. The method of Clause 6, wherein the flag indicative of whether the lifting offset is applied has same value as a flag, associated with a reference meshpatch for the first meshpatch, indicative of whether the lifting offset is applied to the second reference meshpatch.

Clause 8. The method of any of Clauses 1-7, further comprising parsing a flag, received in a bitstream, indicative of whether a lifting offset is applied to a second displacement associated with a second meshpatch of a second mesh that is coded as an intra-meshpatch, determining whether the lifting offset is applied to the second displacement associated with the second meshpatch based on the flag, and decoding the second meshpatch based on whether the lifting offset is applied to the second displacement associated with the second meshpatch.

Clause 9. The method of any of Clauses 1-8, further comprising decoding an attribute bitstream to determine attribute values for the first meshpatch.

Clause 10. The method of any of Clauses 1-9, wherein the first displacement comprises a first displacement vector of a vertex of a subdivided mesh, and wherein the subdivided mesh is based on dividing the first mesh.

Clause 11. A device for decoding meshpatch data, the device comprising one or more memories, and processing circuitry coupled to the one or more memories, the processing circuitry being configured to determine that a first meshpatch of a first mesh is coded as an inter-meshpatch, determine that information indicative of a transform, applied to a first displacement associated with the first meshpatch, is not signaled, in response to the information indicative of the transform not being signaled, determine the transform, applied to the first displacement associated with the first meshpatch, based on transform information included in an atlas frame parameter set (AFPS), and decode the first meshpatch based on the transform.

Clause 12. The device of Clause 11, wherein to determine the transform applied to the first displacement, the processing circuitry is configured to bypass access to memory that stores the information indicative of the transform applied to a displacement associated with a reference meshpatch for the first meshpatch.

Clause 13. The device of any of Clauses 11-12, wherein to determine that information indicative of the transform is not signaled, the processing circuitry is configured to parse a flag indicating that the information indicative of the transform is not signaled.

Clause 14. The device of any of Clauses 11-13, wherein a value of a number of subdivision iterations for the first meshpatch is less than or equal to a number of subdivisions of a reference meshpatch for the first meshpatch.

Clause 15. The device of any of Clauses 11-14, wherein the processing circuitry is configured to parse a flag, received in a bitstream, indicative of whether a lifting offset is applied to a second displacement associated with a second meshpatch of a second mesh that is coded as the inter-meshpatch, determine whether the lifting offset is applied to the second displacement associated with the second meshpatch based on the flag, and decode the second meshpatch based on whether the lifting offset is applied to the second displacement associated with the second meshpatch.

Clause 16. The device of any of Clauses 11-15, wherein the processing circuitry is configured to parse a flag, received in a bitstream, indicative of whether a lifting offset is applied to a second displacement associated with a second meshpatch of a second mesh that is coded as a merge-meshpatch, determine whether the lifting offset is applied to the second displacement associated with the second meshpatch based on the flag, and decode the second meshpatch based on whether the lifting offset is applied to the second displacement associated with the second meshpatch.

Clause 17. The device of Clause 16, wherein the flag indicative of whether the lifting offset is applied has same value as a flag, associated with a reference meshpatch for the first meshpatch, indicative of whether the lifting offset is applied to the reference meshpatch.

Clause 18. The device of any of Clauses 11-17, wherein the processing circuitry is configured to parse a flag, received in a bitstream, indicative of whether a lifting offset is applied to a second displacement associated with a second meshpatch of a second mesh that is coded as an intra-meshpatch, determine whether the lifting offset is applied to the second displacement associated with the second meshpatch based on the flag, and decode the second meshpatch based on whether the lifting offset is applied to the second displacement associated with the second meshpatch.

Clause 19. The device of any of Clauses 11-18, wherein the processing circuitry is configured to decode an attribute bitstream to determine attribute values for the first meshpatch.

Clause 20. The device of any of Clauses 11-19, wherein the first displacement comprises a first displacement vector of a vertex of a subdivided mesh, and wherein the subdivided mesh is based on dividing the first mesh.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding meshpatch data, the method comprising:
determining that a first meshpatch of a first mesh is coded as an inter-meshpatch;
determining that information indicative of a transform, applied to a first displacement associated with the first meshpatch, is not signaled;
in response to the information indicative of the transform not being signaled, determining the transform, applied to the first displacement associated with the first meshpatch, based on transform information included in an atlas frame parameter set (AFPS); and
decoding the first meshpatch based on the transform.

2. The method of claim 1, wherein determining the transform applied to the first displacement comprises bypassing access to memory that stores the information indicative of the transform applied to a displacement associated with a reference meshpatch for the first meshpatch.

3. The method of claim 1, wherein determining that information indicative of the transform is not signaled comprises parsing a flag indicating that the information indicative of the transform is not signaled.

4. The method of claim 1, wherein a value of a number of subdivision iterations for the first meshpatch is less than or equal to a number of subdivisions of a reference meshpatch for the first meshpatch.

5. The method of claim 1, further comprising:
parsing a flag, received in a bitstream, indicative of whether a lifting offset is applied to a second displacement associated with a second meshpatch of a second mesh that is coded as the inter-meshpatch;
determining whether the lifting offset is applied to the second displacement associated with the second meshpatch based on the flag; and
decoding the second meshpatch based on whether the lifting offset is applied to the second displacement associated with the second meshpatch.

6. The method of claim 1, further comprising:
parsing a flag, received in a bitstream, indicative of whether a lifting offset is applied to a second displacement associated with a second meshpatch of a second mesh that is coded as a merge-meshpatch;
determining whether the lifting offset is applied to the second displacement associated with the second meshpatch based on the flag; and
decoding the second meshpatch based on whether the lifting offset is applied to the second displacement associated with the second meshpatch.

7. The method of claim 6, wherein the flag indicative of whether the lifting offset is applied has same value as a flag, associated with a reference meshpatch for the first meshpatch, indicative of whether the lifting offset is applied to the second reference meshpatch.

8. The method of claim 1, further comprising:
parsing a flag, received in a bitstream, indicative of whether a lifting offset is applied to a second displacement associated with a second meshpatch of a second mesh that is coded as an intra-meshpatch;
determining whether the lifting offset is applied to the second displacement associated with the second meshpatch based on the flag; and
decoding the second meshpatch based on whether the lifting offset is applied to the second displacement associated with the second meshpatch.

9. The method of claim 1, further comprising:
decoding an attribute bitstream to determine attribute values for the first meshpatch.

10. The method of claim 1, wherein the first displacement comprises a first displacement vector of a vertex of a subdivided mesh, and wherein the subdivided mesh is based on dividing the first mesh.

11. A device for decoding meshpatch data, the device comprising:
one or more memories; and
processing circuitry coupled to the one or more memories, the processing circuitry being configured to:
determine that a first meshpatch of a first mesh is coded as an inter-meshpatch;
determine that information indicative of a transform, applied to a first displacement associated with the first meshpatch, is not signaled;
in response to the information indicative of the transform not being signaled, determine the transform, applied to the first displacement associated with the first meshpatch, based on transform information included in an atlas frame parameter set (AFPS); and
decode the first meshpatch based on the transform.

12. The device of claim 11, wherein to determine the transform applied to the first displacement, the processing circuitry is configured to bypass access to memory that stores the information indicative of the transform applied to a displacement associated with a reference meshpatch for the first meshpatch.

13. The device of claim 11, wherein to determine that information indicative of the transform is not signaled, the processing circuitry is configured to parse a flag indicating that the information indicative of the transform is not signaled.

14. The device of claim 11, wherein a value of a number of subdivision iterations for the first meshpatch is less than or equal to a number of subdivisions of a reference meshpatch for the first meshpatch.

15. The device of claim 11, wherein the processing circuitry is configured to:
parse a flag, received in a bitstream, indicative of whether a lifting offset is applied to a second displacement associated with a second meshpatch of a second mesh that is coded as the inter-meshpatch;
determine whether the lifting offset is applied to the second displacement associated with the second meshpatch based on the flag; and
decode the second meshpatch based on whether the lifting offset is applied to the second displacement associated with the second meshpatch.

16. The device of claim 11, wherein the processing circuitry is configured to:
parse a flag, received in a bitstream, indicative of whether a lifting offset is applied to a second displacement associated with a second meshpatch of a second mesh that is coded as a merge-meshpatch;
determine whether the lifting offset is applied to the second displacement associated with the second meshpatch based on the flag; and
decode the second meshpatch based on whether the lifting offset is applied to the second displacement associated with the second meshpatch.

17. The device of claim 16, wherein the flag indicative of whether the lifting offset is applied has same value as a flag, associated with a reference meshpatch for the first meshpatch, indicative of whether the lifting offset is applied to the reference meshpatch.

18. The device of claim 11, wherein the processing circuitry is configured to:
parse a flag, received in a bitstream, indicative of whether a lifting offset is applied to a second displacement associated with a second meshpatch of a second mesh that is coded as an intra-meshpatch;
determine whether the lifting offset is applied to the second displacement associated with the second meshpatch based on the flag; and
decode the second meshpatch based on whether the lifting offset is applied to the second displacement associated with the second meshpatch.

19. The device of claim 11, wherein the processing circuitry is configured to:
decode an attribute bitstream to determine attribute values for the first meshpatch.

20. The device of claim 11, wherein the first displacement comprises a first displacement vector of a vertex of a subdivided mesh, and wherein the subdivided mesh is based on dividing the first mesh.
